(19) United States
(12) Patent Application Publication
(10) Pub. No.: US 2014/0344436 A1
(43) Pub. Date: Nov. 20, 2014

(54) Method and Apparatus to Securely Process Streams of Data of Storage Devices of Private Enterprise Clouds in Batch from the Public Cloud

(71) Applicant: Connectloud, Inc., Richardson, TX (US)

(72) Inventors: Habib Madani, Richardson, TX (US); Sameer Siddiqui, Murphy, TX (US); Faisal Azizullah, Plano, TX (US); Adnan Ashraf, Euless, TX (US)

(21) Appl. No.: 14/287,498

(22) Filed: May 27, 2014

Related U.S. Application Data
(63) Continuation-in-part of application No. 14/273,522, filed on May 8, 2014.
Application No. 14/273,522 is a continuation-in-part of application No. 14/287,219, filed on May 27, 2014.
(60) Provisional application No. 61/820,703, filed on May 8, 2013.
(60) Provisional application No. 61/820,704, filed on May 8, 2013.
(60) Provisional application No. 61/820,705, filed on May 8, 2013.
(60) Provisional application No. 61/820,706, filed on May 8, 2013.
(60) Provisional application No. 61/820,707, filed on May 8, 2013.
(60) Provisional application No. 61/820,708, filed on May 8, 2013.
(60) Provisional application No. 61/820,709, filed on May 8, 2013.
(60) Provisional application No. 61/820,712, filed on May 8, 2013.
(60) Provisional application No. 61/820,713, filed on May 8, 2013.
(60) Provisional application No. 61/827,635, filed on May 26, 2013.
(60) Provisional application No. 61/827,636, filed on May 26, 2013.
(60) Provisional application No. 61/827,637, filed on May 26, 2013.
(60) Provisional application No. 61/827,638, filed on May 26, 2013.
(60) Provisional application No. 61/827,639, filed on May 26, 2013.
(60) Provisional application No. 61/827,640, filed on May 26, 2013.
(60) Provisional application No. 61/827,641, filed on May 26, 2013.
(60) Provisional application No. 61/827,642, filed on May 26, 2013.
(60) Provisional application No. 61/827,643, filed on May 26, 2013.
(60) Provisional application No. 61/827,644, filed on May 26, 2013.

(51) Int. Cl. H04L 29/08; H04L 12/24

(52) U.S. Cl. CPC H04L 67/1097; H04L 41/50
USPC 709/223

(57) ABSTRACT

Method and Apparatus for rapid scalable unified infrastructure system management platform are disclosed by discovery of compute nodes, network components across data centers, both public and private for a user; assessment of type, capability, VLAN, security, virtualization configuration of the discovered unified infrastructure nodes and components; configuration of nodes and components covering add, delete, modify, scale; and rapid roll out of nodes and components across data centers both public and private.

### CROSS-REFERENCE

This application claims priority to U.S. application Ser. No. 14/273,522, filed May 8, 2014 entitled “METHOD AND APPARATUS FOR RAPID SCALABLE UNIFIED INFRASTRUCTURE SYSTEM MANAGEMENT PLATFORM”, which claims the benefit of Provisional Patent Application Nos: 61/820,703 filed May 8, 2013 entitled “METHOD AND APPARATUS TO REMOTELY MONITOR INFORMATION TECHNOLOGY INFRASTRUCTURE”; 61/820,704 filed May 8, 2013 entitled “METHOD AND APPARATUS TO ORCHESTRATE ANY-VENDOR IT INFRASTRUCTURE (COMPUTE) CONFIGURATION”; 61/820,705 filed May 8, 2013 entitled “METHOD AND APPARATUS TO ORCHESTRATE ANY-VENDOR IT INFRASTRUCTURE (NETWORK) CONFIGURATION”; 61/820,706 filed May 8, 2013 entitled “METHOD AND APPARATUS TO ORCHESTRATE ANY-VENDOR IT INFRASTRUCTURE (STORAGE) CONFIGURATION”; 61/820,707 filed May 8, 2013 entitled “METHOD AND APPARATUS TO ENABLE LIQUID APPLICATIONS”; 61/820,708 filed May 8, 2013 entitled “METHOD AND APPARATUS TO ENABLE LIQUID APPLICATIONS”; 61/820,709 filed May 8, 2013 entitled “METHOD AND APPARATUS TO ENABLE CONVERGED INFRASTRUCTURE TRUE ELASTIC FUNCTION”; 61/820,712 filed May 8, 2013 entitled “METHOD AND APPARATUS FOR OPERATIONS BIG DATA ANALYSIS AND REAL TIME REPORTING”; and 61/820,713 filed May 8, 2013 entitled “METHOD AND APPARATUS FOR RAPID SCALABLE UNIFIED INFRASTRUCTURE SYSTEM MANAGEMENT PLATFORM”; 61/827,635 filed May 26, 2013 entitled “METHOD AND APPARATUS FOR REMOTELY MANAGEABLE, DECLARATIVELY CONFIGURABLE DATA STREAM AGGREGATOR WITH GUARANTEED DELIVERY FOR PRIVATE CLOUD COMPUTE INFRASTRUCTURE”, 61/827,636 filed May 26, 2013 entitled “METHOD AND APPARATUS FOR REMOTELY MANAGEABLE, DECLARATIVELY CONFIGURABLE DATA STREAM AGGREGATOR WITH GUARANTEED DELIVERY FOR PRIVATE CLOUD COMPUTE INFRASTRUCTURE”, 61/827,637 filed May 26, 2013 entitled “METHOD AND APPARATUS FOR REMOTELY MANAGEABLE, DECLARATIVELY CONFIGURABLE DATA STREAM AGGREGATOR WITH GUARANTEED DELIVERY FOR PRIVATE CLOUD COMPUTE INFRASTRUCTURE”, 61/827,638 filed May 26, 2013 entitled “METHOD AND APPARATUS TO SECURELY PROCESS STREAMS OF DATA OF NETWORK/STORAGE/COMPUTE DEVICES OF PRIVATE ENTERPRISE CLOUDS IN REAL-TIME FROM THE PUBLIC CLOUD”, 61/827,639 filed May 26, 2013 entitled “METHOD AND APPARATUS TO SECURELY PROCESS STREAMS OF DATA OF NETWORK DEVICES OF PRIVATE ENTERPRISE CLOUDS IN REAL-TIME FROM THE PUBLIC CLOUD”, 61/827,640 filed May 26, 2013 entitled “METHOD AND APPARATUS TO SECURELY PROCESS STREAM OF DATA OF COMPUTE DEVICES OF PRIVATE ENTERPRISE CLOUDS IN REAL-TIME FROM THE PUBLIC CLOUD”, 61/827,641 filed May 26, 2013 entitled “METHOD AND APPARATUS TO SECURELY PROCESS STREAMS OF DATA OF STORAGE DEVICES OF PRIVATE ENTERPRISE CLOUDS IN REAL-TIME FROM THE PUBLIC CLOUD”, 61/827,642 filed May 26, 2013 entitled “METHOD AND APPARATUS TO SECURELY PROCESS STREAMS OF DATA OF NETWORK DEVICES OF PRIVATE ENTERPRISE CLOUDS IN BATCH FROM THE PUBLIC CLOUD”, 61/827,643 filed May 26, 2013 entitled “METHOD AND APPARATUS TO SECURELY PROCESS STREAMS OF DATA OF COMPUTE DEVICES OF PRIVATE ENTERPRISE CLOUDS IN BATCH FROM THE PUBLIC CLOUD”,and this application also claims the benefit of U.S. Provisional Patent Application No. 61/827,644 filed May 26, 2013 entitled “METHOD AND APPARATUS TO SECURELY PROCESS STREAMS OF DATA OF STORAGE DEVICES OF PRIVATE ENTERPRISE CLOUDS IN BATCH FROM THE PUBLIC CLOUD”, the contents of which are all herein incorporated by reference in its entirety. This application also claims the benefit of U.S. Nonprovisional patent application Ser. No. 14/287,219 filed May 27, 2014 entitled “METHOD AND APPARATUS FOR DYNAMIC CORRELATION OF LARGE CLOUD FIREWALL FAULT EVENT STREAM”, the contents of which are all herein incorporated by reference in its entirety.

### FIELD

The disclosure generally relates to enterprise cloud computing and more specifically to a seamless cloud across multiple clouds providing enterprises with quickly scalable, secure, multi-tenant automation.

### BACKGROUND

Cloud computing is a model for enabling on-demand network access to a shared pool of configurable computing resources/service groups (e.g., networks, servers, storage, applications, and services) that can ideally be provisioned and released with minimal management effort or service provider interaction.

Software as a Service (SaaS) provides the user with the capability to use a service provider's applications running on a cloud infrastructure. The applications are accessible from various client devices through either a thin client interface, such as a web browser or a program interface. The user does not manage or control the underlying cloud infrastructure including network, servers, operating systems, storage, or even individual application capabilities.

Infrastructure as a Service (IaaS) provides the user with the capability to provision processing, storage, networks, and other fundamental computing resources where the user is able to deploy and run arbitrary software, which can include operating systems and applications. The user does not manage or control the underlying cloud infrastructure but has control over operating systems, storage, and deployed applications; and possibly limited control of select networking components (e.g., host firewalls).

Platform as a Service (PaaS) provides the user with the capability to deploy onto the cloud infrastructure user-created or acquired applications created using programming languages, libraries, services, and tools supported by the provider. The user does not manage or control the underlying cloud infrastructure including network, servers, operating systems, or storage, but has control over the deployed applications and possibly configuration settings for the application-hosting environment.

Cloud deployment may be Public, Private or Hybrid. A Public Cloud infrastructure is provisioned for open use by the general public. It may be owned, managed, and operated by a business, academic, or government organization. It exists on the premises of the cloud provider. A Private Cloud infrastructure is provisioned for exclusive use by a single organization comprising multiple users (e.g., business units). It may be owned, managed, and operated by the organization, a third party, or some combination of them, and it may exist on or off premises. A Hybrid Cloud infrastructure is provisioned for exclusive use by a single organization comprising multiple users (e.g., business units). It may be owned, managed, and operated by the organization, a third party, or some combination of them, and it may exist on or off premises.

The promise of enterprise cloud computing was supposed to lower capital and operating costs and increase flexibility for the Information Technology (IT) department. However lengthy delays, cost overruns, security concerns, and loss of budget control have plagued the IT department. Enterprise users must juggle multiple cloud setups and configurations, along with aligning public and private clouds to work together seamlessly. Turning up of cloud capacity (cloud stacks) can take months and many engineering hours to construct and maintain. High-dollar professional services are driving up the total cost of ownership dramatically. The current marketplace includes different ways of private cloud build-outs. Some build internally hosted private clouds while others emphasize Software-Defined Networking (SDN) controllers that relegate switches and routers to mere plumbing.

The cloud automation market breaks down into several types of vendors, ranging from IT operations management (ITOM) providers, limited by their complexity, to so-called fabric-based infrastructure vendors that lack breadth and depth in IT operations and service. To date, true value in enterprise cloud has remained elusive, just out of reach for most organizations. No vendor provides a complete Cloud Management Platform (CMP) solution.

Therefore there is a need for systems and methods that create a unified fabric on top of multiple clouds reducing costs and providing limitless agility.

### SUMMARY OF THE INVENTION

Additional features and advantages of the disclosure will be set forth in the description which follows, and will become apparent from the description, or can be learned by practice of the herein disclosed principles by those skilled in the art. The features and advantages of the disclosure can be realized and obtained by means of the disclosed instrumentalities and combinations as set forth in detail herein. These and other features of the disclosure will become more fully apparent from the following description, or can be learned by the practice of the principles set forth herein.

A Cloud Management Platform is described for fully unified compute and virtualized software-based networking components empowering enterprises with quickly scalable, secure, multi-tenant automation across clouds of any type, for clients from any segment, across geographically dispersed data centers.

In one embodiment, systems and methods are described for sampling of data center devices alerts; selecting an appropriate response for the event; monitoring the end node for repeat activity; and monitoring remotely.

In another embodiment, systems and methods are described for discovery of compute nodes; assessment of type, capability, VLAN, security, virtualization configuration of the discovered compute nodes; configuration of nodes covering add, delete, modify, scale; and rapid roll out of nodes across data centers.

In another embodiment, systems and methods are described for discovery of network components including routers, switches, server load balancers, firewalls; assessment of type, capability, VLAN, security, access lists, policies, virtualization configuration of the discovered network components; configuration of components covering add, delete, modify, scale; and rapid roll out of network atomic units and components across data centers.

In another embodiment, systems and methods are described for discovery of storage components including storage arrays, disks, SAN switches, NAS devices; assessment of type, capability, VLAN, VSAN, security, access lists, policies, virtualization configuration of the discovered storage components; configuration of components covering add, delete, modify, scale; and rapid roll out of storage atomic units and components across data centers.

In another embodiment, systems and methods are described for discovery of workload and application components within data centers; assessment of type, capability, IP, TCP, bandwidth usage, threads, security, access lists, policies, virtualization configuration of the discovered application components; real time monitoring of the application components across data centers public or private; and capacity analysis and intelligence to adjust underlying infrastructure thus enabling liquid applications.

In another embodiment, systems and methods are described for analysis of capacity of workload and application components across public and private data centers and clouds; assessment of available infrastructure components across the data centers and clouds; real time roll out and orchestration of application components across data centers public or private; and rapid configurations of all needed infrastructure components.

In another embodiment, systems and methods are described for analysis of capacity of workload and application components across public and private data centers and clouds; assessment of available infrastructure components across the data centers and clouds; comparison of capacity with availability; real time roll out and orchestration of application components across data centers public or private within allowed threshold bringing about true elastic behavior; and rapid configurations of all needed infrastructure components.

In another embodiment, systems and methods are described for analysis of all remote monitored data from diverse public and private data centers associated with a particular user; assessment of the analysis and linking it to the user applications; alerting user with one line message for high priority events; and additional business metrics and return on investment addition in the user configured parameters of the analytics.

In another embodiment, systems and methods are described for discovery of compute nodes, network components across data centers, both public and private for a user; assessment of type, capability, VLAN, security, virtualization configuration of the discovered unified infrastructure nodes and components; configuration of nodes and components covering add, delete, modify, scale; and rapid roll out of nodes and components across data centers both public and private.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram of an exemplary hardware configuration in accordance with the principles of the present invention;

FIG. 2 is a block diagram describing a tenancy configuration wherein the Enterprise hosts systems and methods within its own data center in accordance with the principles of the present invention;

FIG. 3 is a block diagram describing a super tenancy configuration wherein the Enterprise uses systems and methods hosted in a cloud computing service in accordance with the principles of the present invention;

FIG. 4 is a logical diagram of the Enterprise depicted in FIG. 1 in accordance with the principles of the present invention;

FIG. 5 illustrates a logical view that an Enterprise administrator and Enterprise user have of the uCloud Platform depicted in FIG. 1 in accordance with the principles of the present invention;

FIG. 6 illustrates a flow diagram of a service catalog classifying data center resources into service groups; selecting a service group and assigning it to end users;

FIG. 7 illustrates a flow diagram of mapping service group categories to user groups that have been given access to a given service group, in accordance with the principles of the present invention;

FIG. 8 illustrates the Cloud administration process utilizing the tenant cloud instance manager as well as the manager of manager and the ability of uCloud platform to logically restrict and widen scope of Cloud Administration, as well as monitoring;

FIG. 9 illustrates a hierarchy diagram of the Cloud administration process utilizing the tenant cloud instance manager as well as the manager of manager and the ability of uCloud platform to logically restrict and widen scope of Cloud Administration in accordance with the principles of the present invention;

FIG. 10 illustrates the logical flow of information from the uCloud Platform depicted in FIG. 1 to a Controller Node in a given Enterprise for compute nodes;

FIG. 11 illustrates the logical flow of information from the uCloud Platform depicted in FIG. 1 to the Controller Node in a given Enterprise for network components;

FIG. 12 illustrates the logical flow of information from the uCloud Platform to the Controller Node in a given Enterprise for storage devices;

FIG. 13 illustrates the application-monitoring component of the uCloud Platform in accordance with the principles of the present invention;

FIG. 14 illustrates the application-orchestration component of the uCloud Platform in accordance with the principles of the present invention;

FIG. 15 illustrates the integration of the application-orchestration and application-monitoring components of the uCloud Platform in accordance with the principles of the present invention;

FIG. 16 illustrates the big data component of the uCloud Platform depicted in FIG. 1 and the relationship to the monitoring component of the platform

FIG. 17 illustrates the process of deploying uCloud within an Enterprise environment;

FIG. 18 illustrates a flow diagram in accordance with the principles of the present invention;

FIG. 19 illustrates a flow diagram in accordance with the principles of the present invention;

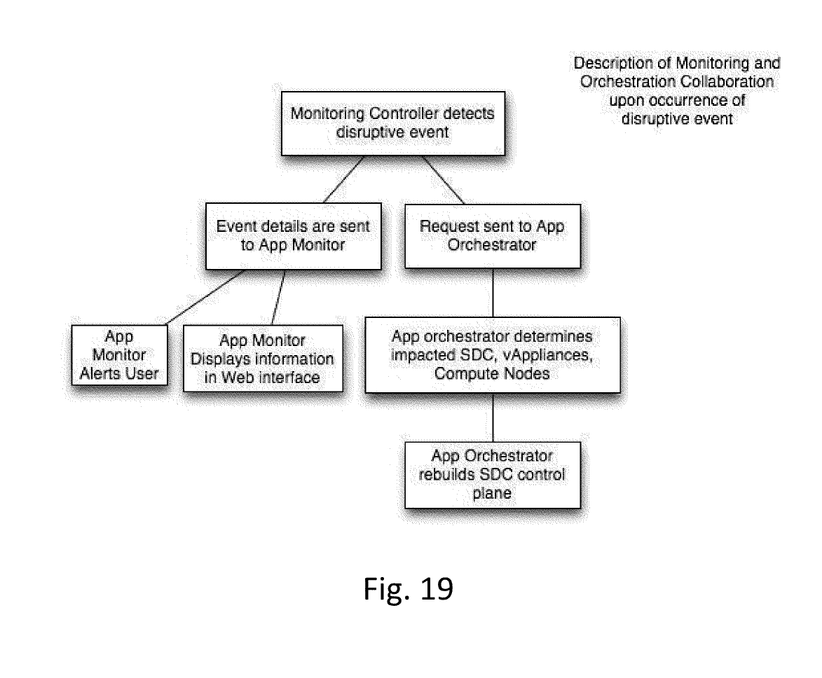

FIG. 20 illustrates a flow diagram in accordance with the principles of the present invention;

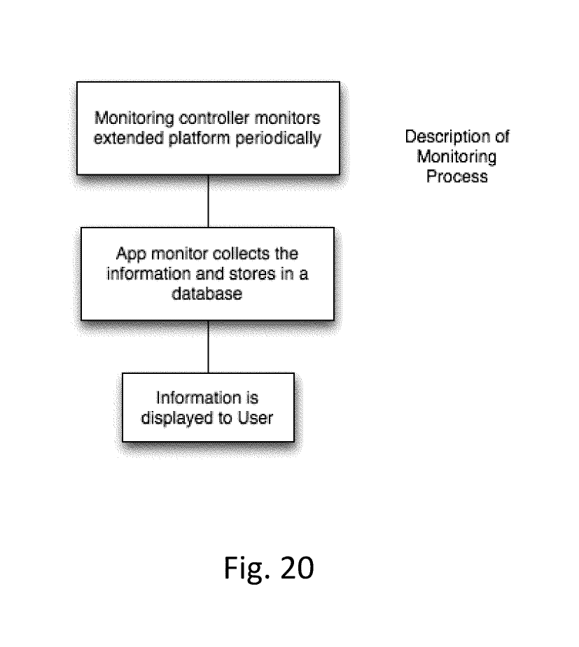

FIG. 21 illustrates a flow diagram in accordance with the principles of the present invention;

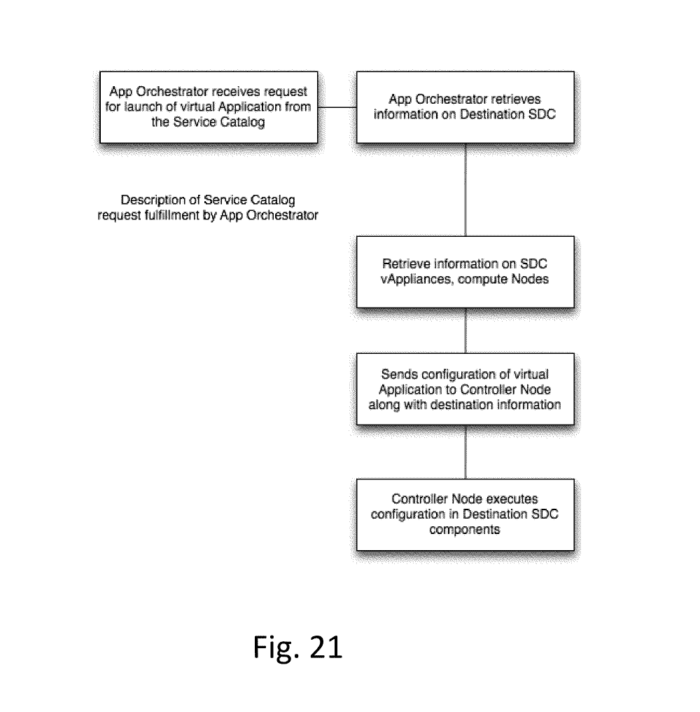

FIG. 22 illustrates a block diagram in accordance with the principles of the present invention;

FIG. 23 illustrates a block diagram in accordance with the principles of the present invention; and

FIG. 24 illustrates a block diagram in accordance with the principles of the present invention;

FIG. 25 illustrates a block diagram in accordance with the principles of the present invention;

FIG. 26 illustrates a block diagram in accordance with the principles of the present invention;

FIG. 27 illustrates a block diagram in accordance with the principles of the present invention;

FIG. 28 illustrates a block diagram in accordance with the principles of the present invention;

FIG. 29 illustrates a block diagram in accordance with the principles of the present invention;

FIG. 30 illustrates a combined block and flow diagram in accordance with the principles of the present invention;

FIG. 31 illustrates a combined block and flow diagram in accordance with the principles of the present invention;

FIG. 32 illustrates a combined block and flow diagram in accordance with the principles of the present invention;

FIG. 33 illustrates a block diagram in accordance with the principles of the present invention;

FIG. 34 illustrates a combined block and flow diagram in accordance with the principles of the present invention;

FIG. 35 illustrates a combined block and flow diagram in accordance with the principles of the present invention; and

FIG. 36 illustrates a combined block and flow diagram in accordance with the principles of the present invention.

### DETAILED DESCRIPTION

The FIGURES and text below, and the various embodiments used to describe the principles of the present invention are by way of illustration only and are not to be construed in any way to limit the scope of the invention. It is also to be understood that the terminology used herein is for the purpose of describing particular embodiments only, and is not intended to be limiting, since the scope of the present invention will be limited only by the appended claims. A Person Having Ordinary Skill in the Art (PHOSITA) will readily recognize that the principles of the present invention maybe implemented in any type of suitably arranged device or system. Specifically, while the present invention is described with respect to use in cloud computing services and Enterprise hosting, a PHOSITA will readily recognize other types of networks and other applications without departing from the scope of the present invention.

Unless defined otherwise, all technical and scientific terms used herein have the same meaning as commonly understood by a PHOSITA to which this invention belongs. Although any methods and materials similar or equivalent to those described herein can also be used in the practice or testing of the present invention, a limited number of the exemplary methods and materials are described herein.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

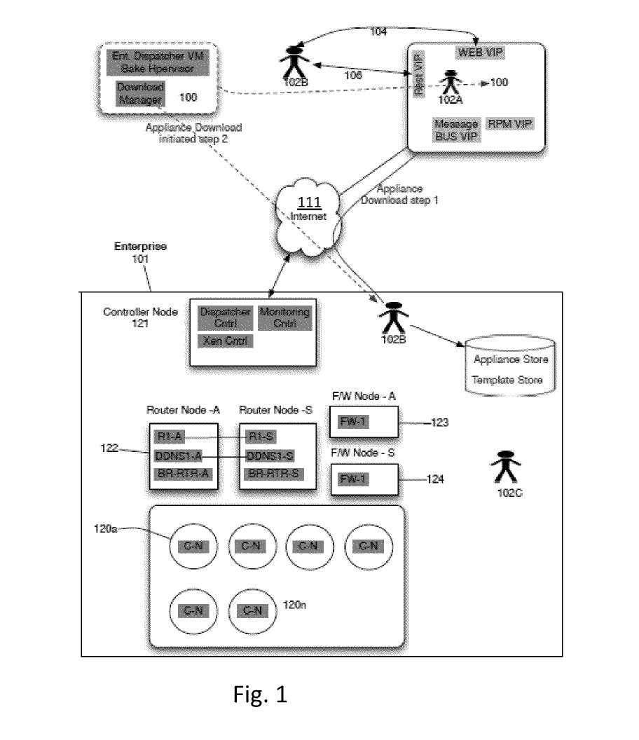

Reference is now made to FIG. 1 that depicts a block diagram of an exemplary hardware configuration in accordance with the principles of the present invention. A uCloud Platform 100 combining self-service cloud orchestration with a Layer 2- and Layer 3-capable encrypted virtual network may be hosted by a cloud computing service such as but not limited to, Amazon Web Services or directly by an enterprise such as but not limited to, a service provider (e.g. Verizon or AT&T), provides a web interface 104 with a Virtual IP (VIP) address, a Rest API interface 106 with a Virtual IP (VIP), a RPM Repository Download Server and, a message bus 110, and a vAppliance Download Manager 112. Connections to and from web interface 104, Rest API interface 106, RPM Repository Download Server, message bus 110, and vAppliance Download Manager 112 are preferably SSL secured. Interfaces 104, 106, 107 and 109 are preferably VeriSign certificate based with Extra Validation (EV), allowing for 128-bit encryption and third party validation for all communication on the interfaces. In addition to SSL encryption on Message BUS 110, each message sent across on interface 107 to a Tenant environment is preferably encrypted with a Public/Private key pair thus allowing for extra security per Enterprise/Service Provider communication. The Public/Private key pair security per Tenant prevents accidental information leakage to be shared across other Tenants. Interfaces 108 and 110 are preferably SSL based (with self-signed) certificates with 128-bit encryption. In addition to communication interfaces, all Tenant passwords and Credit Card information stored are preferably encrypted.

Controller node 121 performs dispatched control, monitoring control and Xen Control. Dispatched control entails executing, or terminating, instructions received from the uCLoud Platform 100. Xen control is the process of translating instructions received from uCLoud Platform 100 into a Xen Hypervisor API. Monitoring is performed by the monitor controller by periodically gathering management plane information data in an extended platform for memory, CPU, network, and storage utilizations. This information is gathered and then sent to the management plane. The extended platform comprises vAppliance instances that allow instantiation of Software Defined clouds. The management, control, and data planes in the tenant environment are contained within the extended platform. RPM Repository Download Server 108 downloads RPMs (packages of files that contain a programmatic installation guide for the resources contained) when initiated by Control node 121. The message bus VIP 110 couples between the Enterprise 101 and the uCloud Platform 100. A Software Defined Cloud (SDC) may comprise a plurality of Virtual Machines (vAppliances) such as, but not limited to a Bridge Router (BR-RTR, Router, Firewall, and DHCP-DNS (DDNS) across multiple virtual local area networks (VLANs) and potentially across data centers for scale, coupled through Compute node (C-N) nodes (aka servers) 120a-120n. The SDC represents a logical linking of select compute nodes (aka servers) within the enterprise cloud. Virtual Networks running on Software Defined Routers 122 and Demilitarized Zone (DMZ) Firewalls are referred to as vAppliances. All Software defined networking components are dynamic and automated, provisioned as needed by the business policies defined in the Service Catalogue by the Tenant Administrator.

The uCloud Platform 100 supports policy-based placement of vAppliances and compute nodes (120a-120n). The policies permit the Tenant Administrator to do auto or static placement thus facilitating creation of dedicated hardware environment Nodes for Tenant's Virtual Machine networking deployment base.

The uCloud Platform 100 created SDC environment enables the Tenant Administrator to create lines of businesses or in other words, department groups with segregated networked space and service offerings. This facilitates Tenant departments like IT, Finance and development to all share the same SDC space but at the same time be isolated by networking and service offerings.

The uCloud Platform 100 supports deploying SDC vAppliances in redundant pair topologies. This allows for key virtual networking building block host nodes to be swapped out and new functional host nodes be inserted managed through uCloud Platform 100. SDCs can be dedicated to data centers, thus two unique SDCs in different data centers can provide the Enterprise a disaster recovery scenario.

SDC vAppliances are used for the logical configuration of SDC's within a tenants private cloud. A Router Node is a physical server, or node, in an tenant's private cloud that may be used to host certain vAppliances relating SDC networking. Such vAppliances may include the Router, DDNS, and BR-RTR (Bridge Router) vApplications that may be used to route internet traffic to and from an SDC, as well as establish logical boundaries for SDC accessibility. Two Router Nodes exist, an active Node (−A) and a standby Node (−S), used in the event that the active node experiences failure. The Firewall Nodes, also present in an active and standby pair, are used to filter internet traffic coming into an SDC. There is a singular vAppliance that uses the Firewall Node, that being the Firewall vAppliance. The vAppliances are configured through use of vAppliance templates, which are downloaded and stored by the tenant in the appliance store/Template store.

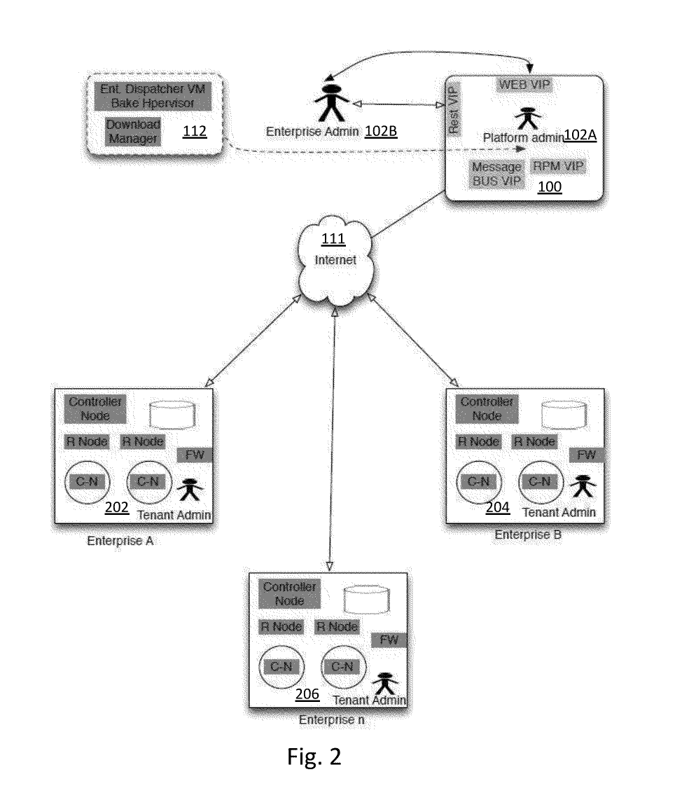

Reference is now made to FIG. 2 depicting a block diagram describing a tenancy configuration wherein the Enterprise hosts systems and methods within its own data center in accordance with the principles of the present invention. The uCloud platform 100 is hosted directly on an enterprise 200 which may be a Service Provider such as, but not limited to, Verizon FIOS or AT&T uVerse, which serves tenants A-n 202, 204 and 206, respectively. Alternatively, enterprise 200 may be an enterprise having subsidiaries or departments 202, 204 and 206 that it chooses to keep segregated.

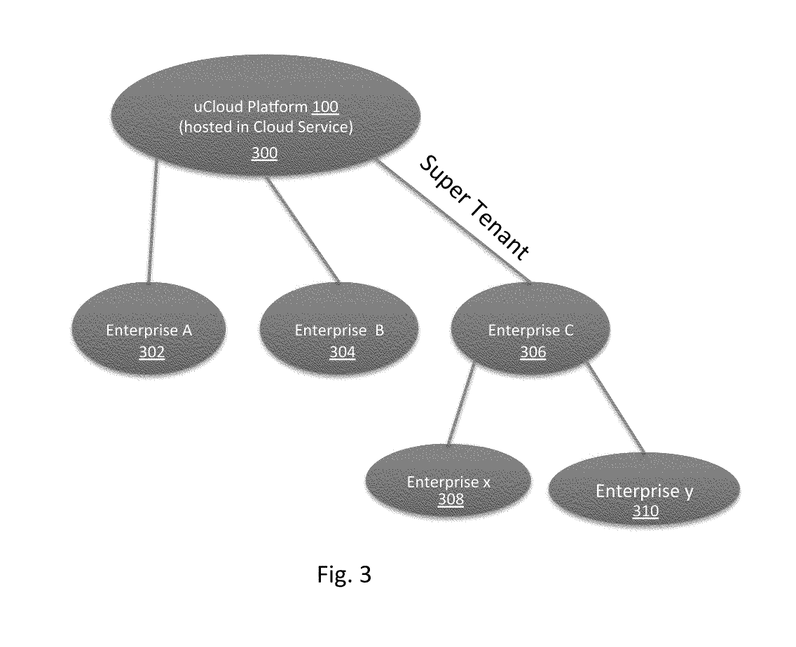

Reference is now made to FIG. 3 depicting a block diagram of a super tenancy configuration wherein the Enterprise uses systems and methods hosted in a cloud computing service 300 in accordance with the principles of the present invention. In this configuration, the uCloud platform is hosted by a cloud computing service 300 that services Enterprises 302, 304 and 306. It should be understood that more or less Enterprises could be serviced without departing from the scope of the invention. In the present example, Enterprise C 306 has sub tenants. Enterprise C 306 may be a service provider (e.g. Verizon FIOS or AT&T u-Verse) or an Enterprise having subsidiaries or departments that it chooses to keep segregated.

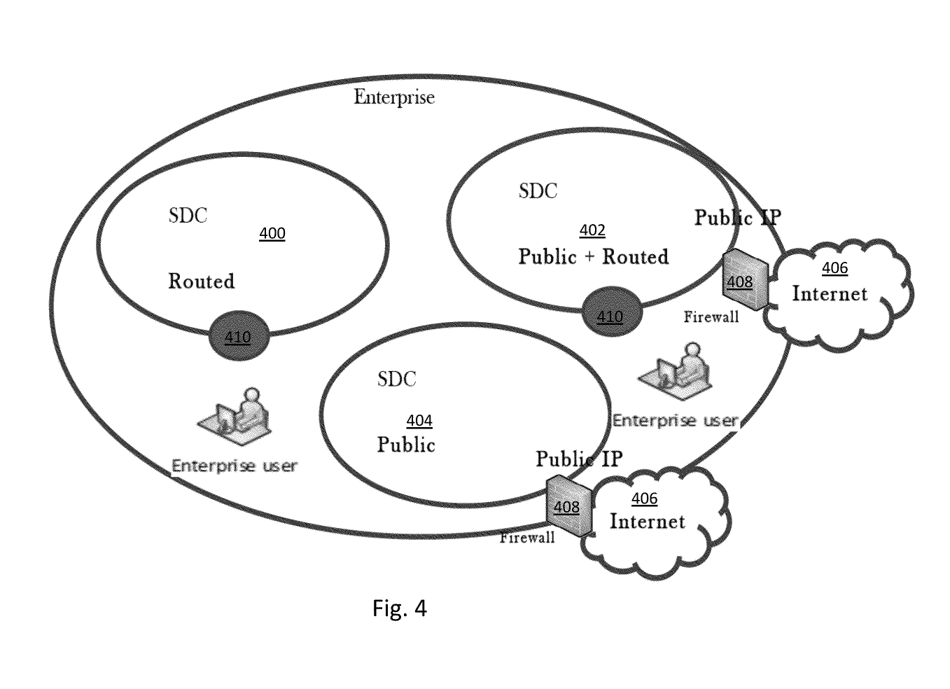

Reference is now made to FIG. 4 depicting a block diagram describing permutations of a Software Defined Cloud (SDC) in accordance with the principles of the present invention. The SDC can be of three types namely Routed 400, Public Routed 402 and Public 404. Routed and Routed Public SDC types 400 and 402 respectively are designed to be reachable through the Enterprise IP address space, with the caveat that the Enterprise IP address space cannot be in the same collision domain as these types of SDC IP network space. Furthermore, Routed and Public Routed SDC 400 and 402 respectively can re-use same IP network space without colliding with each other. The Public SDC 404 is Internet 406 facing only, it can have overlapping collision IP space with the Enterprise network. Public SDC 404 further provides Internet facing access only. SDC IP schema is automatically managed by the uCloud platform 100 and does not require Tenant Administrator intervention.

SDC Software Defined Firewalls 408 are of two/one type, Internet gateway (for DMZ use). The SDC vAppliances (e.g. Firewall 408, Router 410) and compute nodes (120a-120n) provide a scalable Cloud deployment environment for the Enterprise. The scalability is achieved through round robin and dedicated hypervisor host nodes. The host pool provisioning management is performed through uCloud Platform 100. The uCloud Platform 100 manages dedicated nodes for the compute nodes (120a-120n), it allows for fault isolation across the Tenant's Virtual Machine workload deployment base.

Referring back to FIG. 1, an uCloud Platform administrator 102A, an Enterprise administrator 102B, and an Enterprise User 102C without administrator privileges are depicted. To deploy uCloud platform 100, Enterprise administrator 102B grants uCloud Platform administrator 102A information regarding the enterprise environment 101 and the hardware residing within it (e.g. compute nodes 120a-n). After this information is supplied, platform 100 creates a customized package that contains a Controller Node 121 designed for the Enterprise 101. Enterprise administrator 102B downloads and install Controller Node 121 into the Enterprise environment 101. The uCloud Platform 100 then generates a series of tasks, and communicates these tasks indirectly with Controller Node 121, via the internet 111. The communication is preferably done indirectly so as to eliminate any potential for unauthorized access to the Enterprise's information. The process preferably requires uCloud platform 100 to leave the tasks in an online location, and the tasks are only accessible to the unique Controller Node 121 present in an Enterprise Environment 101. Controller Node 121 then fulfills the tasks generated by uCloud platform 100, and thus configures the compute 122, network 123, and storage 120a-n capability of the Enterprise environment 101.

Upon completion of the hardware configuration, uCloud platform 100 is deployed in the Enterprise environment 101. The uCloud platform 100 monitors the Enterprise environment 101 and preferably communicates with Controller Node 121 indirectly. Enterprise administrator 102B and Enterprise User 102C use the online portal to access uCloud platform 100 and to operate their private cloud.

Software defined clouds (SDCs) are created within the uCloud platform 100 configured Enterprise 101. Each SDC contains compute nodes that are logically linked to each other, as well as certain network and storage components (logical and physical) that create logical isolation for those compute nodes within the SDC. As discussed above, an enterprise 101 may create three types of SDC's: Routed 400, Public Routed 402, and Public 404 as depicted in FIG. 4. The difference, as illustrated by FIG. 4, is how each SDC is accessible to an Enterprise user 102C.

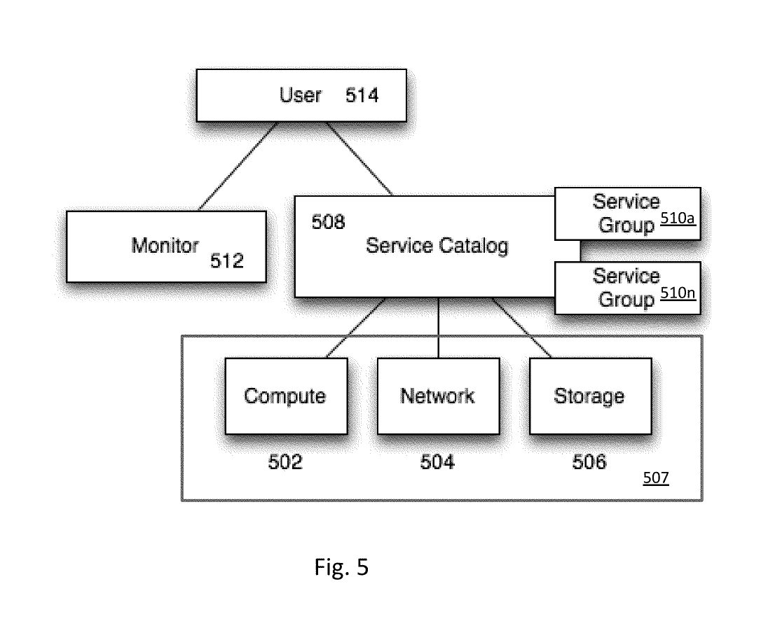

Reference is now made to FIG. 5 that depicts a logical view of the uCloud Platform 100 that the Enterprise administrator 102B and Enterprise user 102C have in accordance with the principles of the present invention. Resources compute 502, network 504 and storage 506 residing in a data center 507 are coupled to the service catalog 508 that classifies the resources into service groups 510a-510n. A monitor 512 is coupled to the service catalog 508 and to a user 514. User 514 is also coupled to service catalog 508. Service catalog 508 is configured to designate various data center items (compute 502, network 504, and storage 506) as belonging to certain service groups 510a-510n. The Service catalog 508 also maps the service groups to the appropriate User. Additionally, monitor 512 monitors and controls the service groups belonging to a specific User.

The service catalog 508 allows for a) the creation of User defined services: a service is a virtual application, or a category/group of virtual applications to be consumed by the Users or their environment, b) the creation of categories, c) the association of virtual appliances to categories, d) the entitlement of services to tenant administrator-defined User groups, and e) the Launch of services by Users through an app orchestrator. The service catalog 508 may then create service groups 510a-510n. A service group is a classification of certain data center components e.g. compute Nodes, network Nodes, and storage Nodes.

Monitoring in FIG. 5 is done by periodically gathering management plane information data in the extended platform for memory, CPU, network, storage utilizations. This information is gathered and then sent to the management plane.

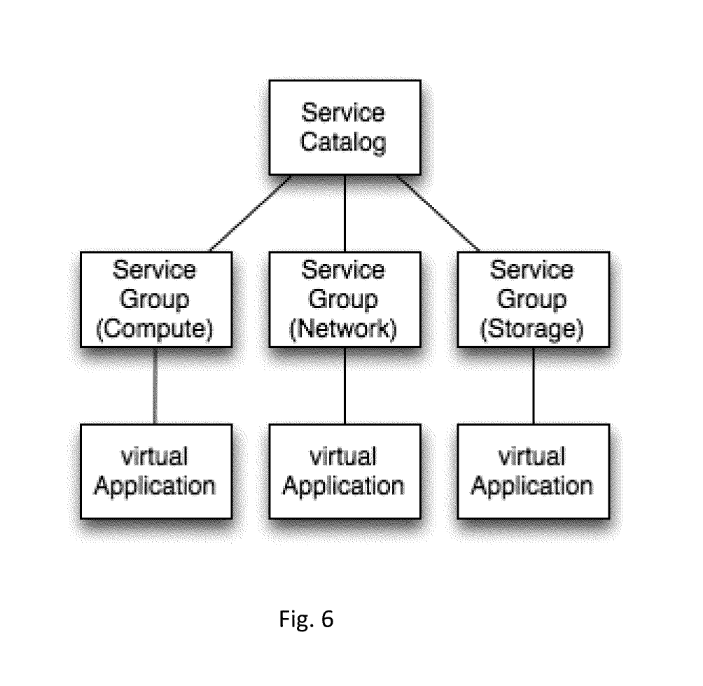

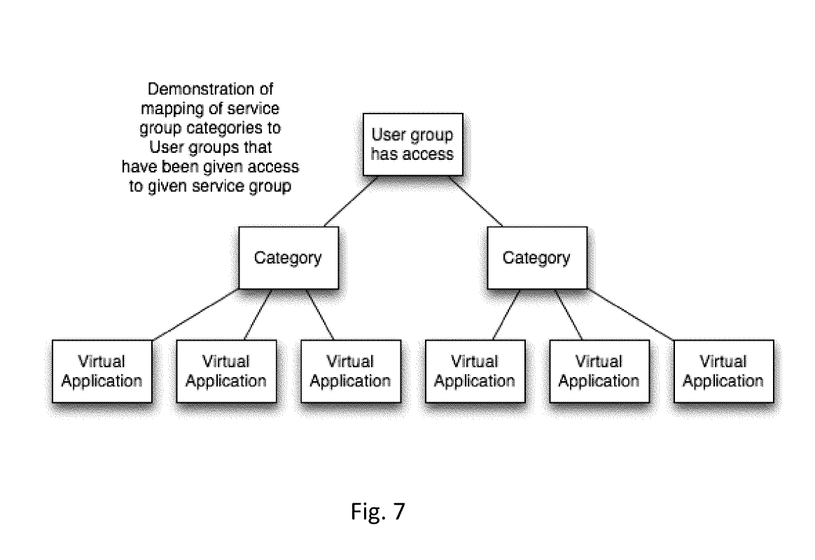

FIG. 6 illustrates a flow diagram of a service catalog classifying data center resources into service groups; selecting a service group and assigning it to end users. FIG. 7 illustrates a flow diagram of mapping service group categories to user groups that have been given access to a given service group, in accordance with the principles of the present invention.

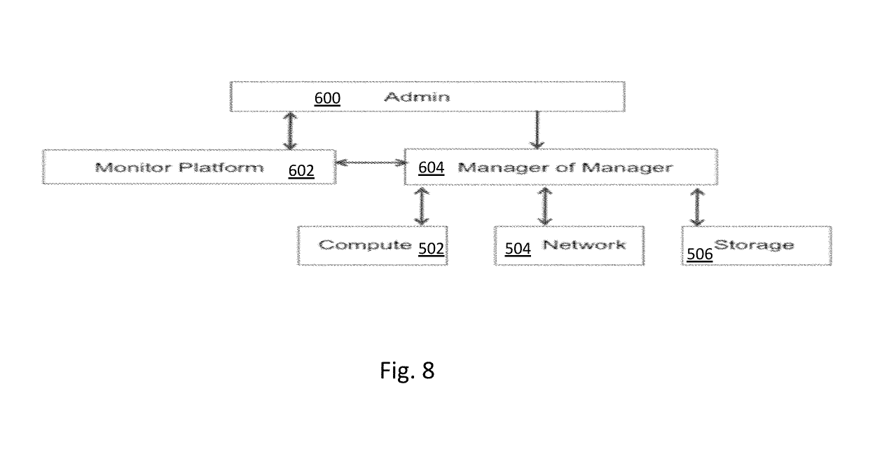

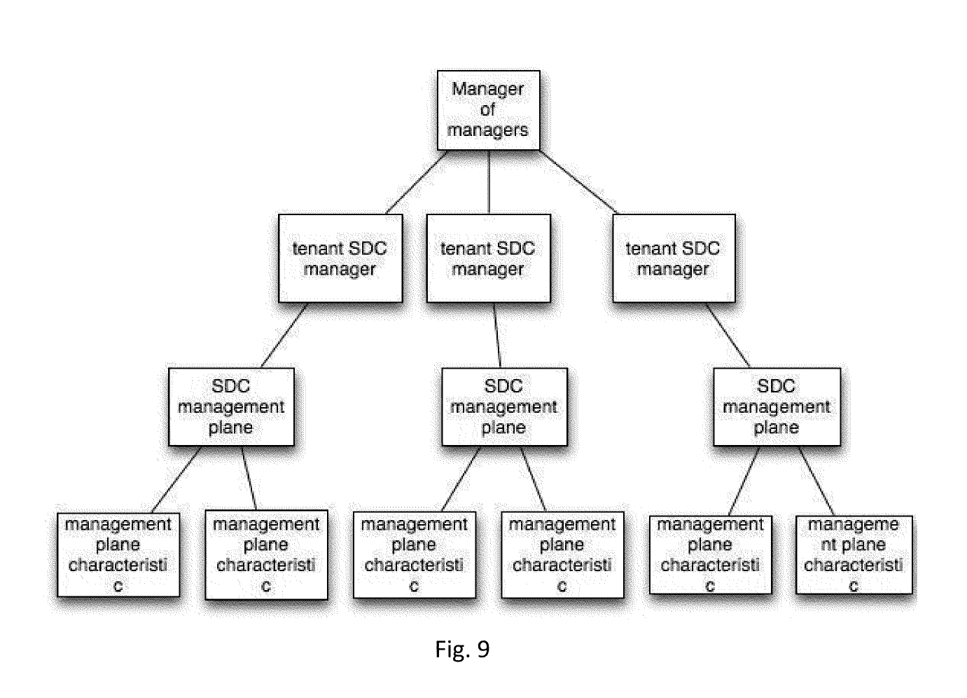

Reference is now made to FIGS. 8 and 9 that illustrate the Cloud administration process its hierarchy respectively, utilizing the tenant cloud instance manager as well as the manager of manager and the ability of uCloud platform to logically restrict and widen scope of Cloud Administration as well as monitoring;

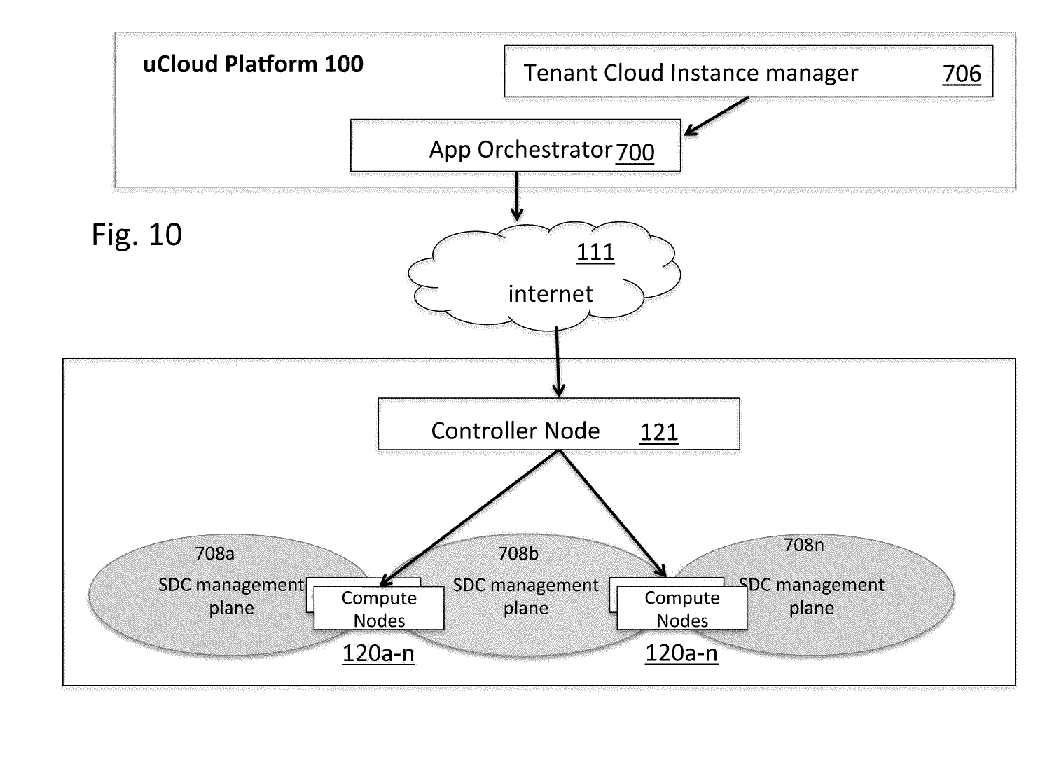

It should be noted that reference throughout the specification to “tenants” includes both enterprises and service providers as “super-tenants”. Each Software Defined Cloud (SDC) has a management plane, as well as a Data Plane and Control Plane. The Management plane provisions, configures, and operates the cloud instances. The Control plane creates and manages the static topology configuration across network and security domains. The Data plane is part of the network that carries user networking traffic. Together, these three planes govern the SDC's abilities and define the logical boundaries of a given SDC. The Manager of Manager 604 in uCLoud Platform 100 which is accessible only to the uCloud Platform administrator 102A, manages the tenant cloud instance manager 706 (FIG. 10) in every tenant private cloud. The hierarchy of this management is shown in FIG. 9.

Referring now to FIGS. 10, 11 and 12, the tenant cloud instance manager 706 is responsible for overseeing the management planes of various SDC's as well as any other virtual Applications that the tenant is running in its compute Nodes, network components and storage devices, respectively. The uCloud Platform 100 generates commands related to the management of Compute Nodes 120a-n based on tenant cloud instance manager 706 and extended platform orchestrator. The extended platform orchestrator is responsible for intelligently dispersing commands to create, manage, delete, or modify components of a tenant's uCloud platform 100, or the extended platform based on predetermined logic. These commands are communicated indirectly to the Controller Node 121 of a specific Enterprise environment. The controller node 121 then accesses the compute Nodes 120a-n and executes the commands. The launched cloud instance (SDC) management planes are depicted as 708a-n in FIG. 10. The ability of the tenant cloud instance manager 706 to modify and delete SDC management plane characteristics (compute, network, storage, Users, and business processes is provided over the internet 111. Tenants (depicted in FIGS. 3 as 302, 304 and 306) each have a Tenant cloud instance manager 706 viewable to through the web interface 104 depicted in FIG. 1.

Again with reference to FIG. 8, the monitoring platform 602 is not limited to one controller but rather, its scope is all controllers within the platform. The monitoring done by the controller 512 (FIG. 5) is performed in a limited capacity, periodically gathering management plane information data in the extended platform for memory, CPU, network, storage utilizations. This information is gathered and then sent to the tenant cloud instance manager 706.

Centralized management view of all management planes across the tenants is provided to uCloud Platform administrator 102A through the uCloud web interface 104 depicted in FIG. 1.

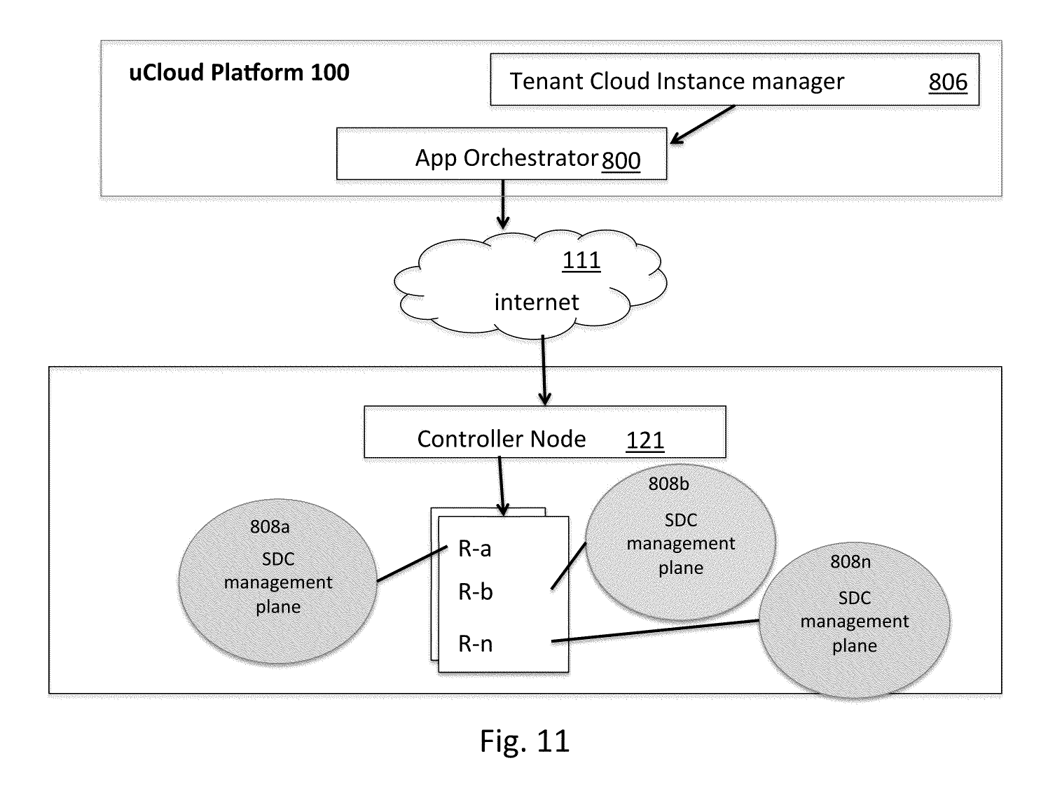

Reference is now made to FIG. 11 illustrating the logical flow of information from the uCloud Platform 100 to the Controller Node in a given Enterprise. The uCloud Platform 100 generates commands related to the management of Network components 122 and 123 based on tenant cloud instance manager and extended platform orchestrator element. The extended platform orchestrator is responsible for intelligently dispersing commands to create, manage, delete, or modify components of 100, or the extended platform based on predetermined logic. These commands are communicated indirectly to the Controller Node (121 in FIG. 1) of a specific Enterprise environment 101. The controller node then accesses the pertinent router nodes, and within them, the pertinent vAppliances, and executes the commands.

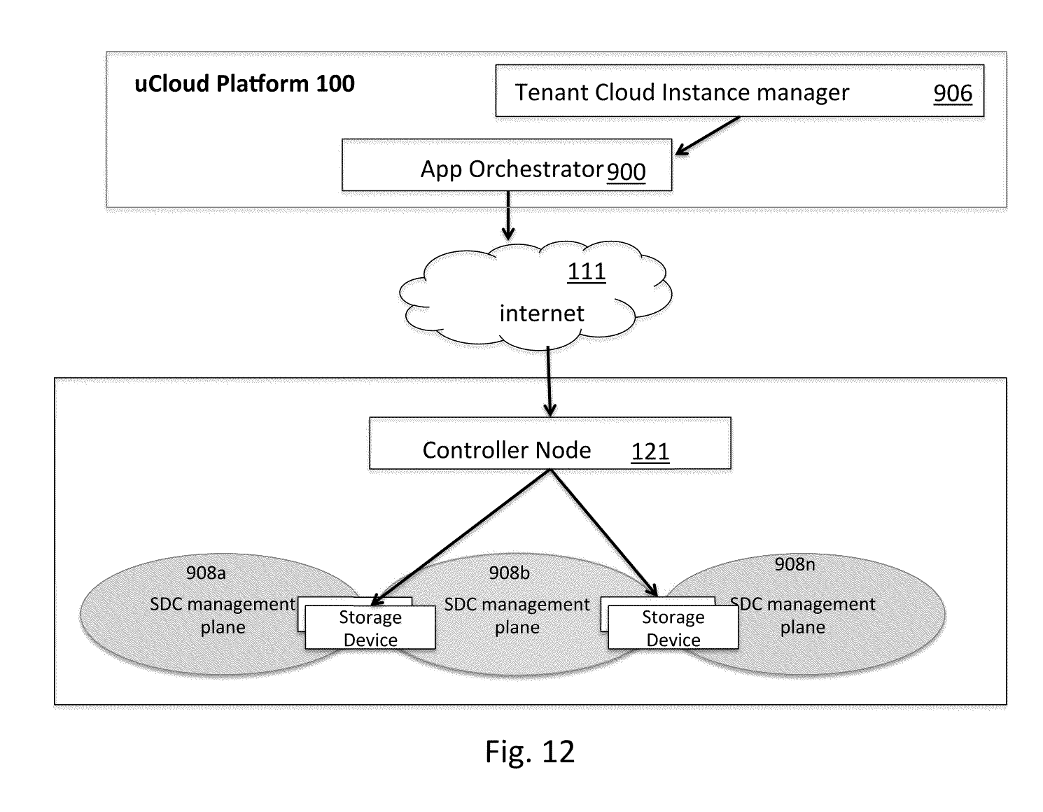

Reference is now made to FIG. 12 illustrating the logical flow of information from the uCloud Platform to the Controller Node in a given Enterprise. The uCloud Platform 100 generates commands related to the management of Storage components tenant cloud instance manager and extended platform orchestrator. The extended platform orchestrator is responsible for intelligently dispersing commands to create, manage, delete, or modify components of 100, or the extended platform based on predetermined logic. These commands are communicated indirectly to the Controller Node 121 of a specific Enterprise environment. The controller node then accesses the pertinent storage devices and executes the commands.

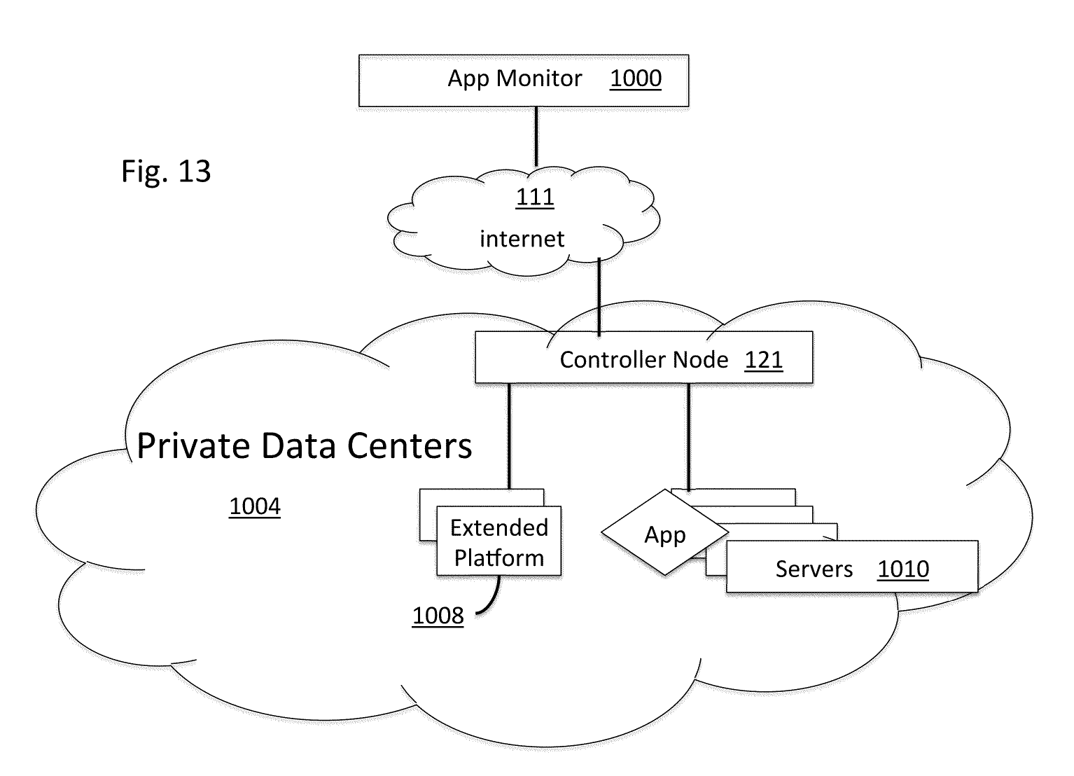

Reference is now made to FIG. 13 illustrating the application-monitoring component of the uCloud Platform 100 in accordance with the principles of the present invention. The platform indirectly communicates with the Controller Node which monitors the application health. This entails passively monitoring a) the state of Enterprise SDC's (400, 402, 404 in FIG. 4), and b) the capacity of the Enterprise infrastructure. The Controller Node also actively monitors the state of the processes initiated by the uCloud Platform and executed by the Controller Node. The Controller Node relays the status of the above components to the uCloud Platform monitoring component 1000.

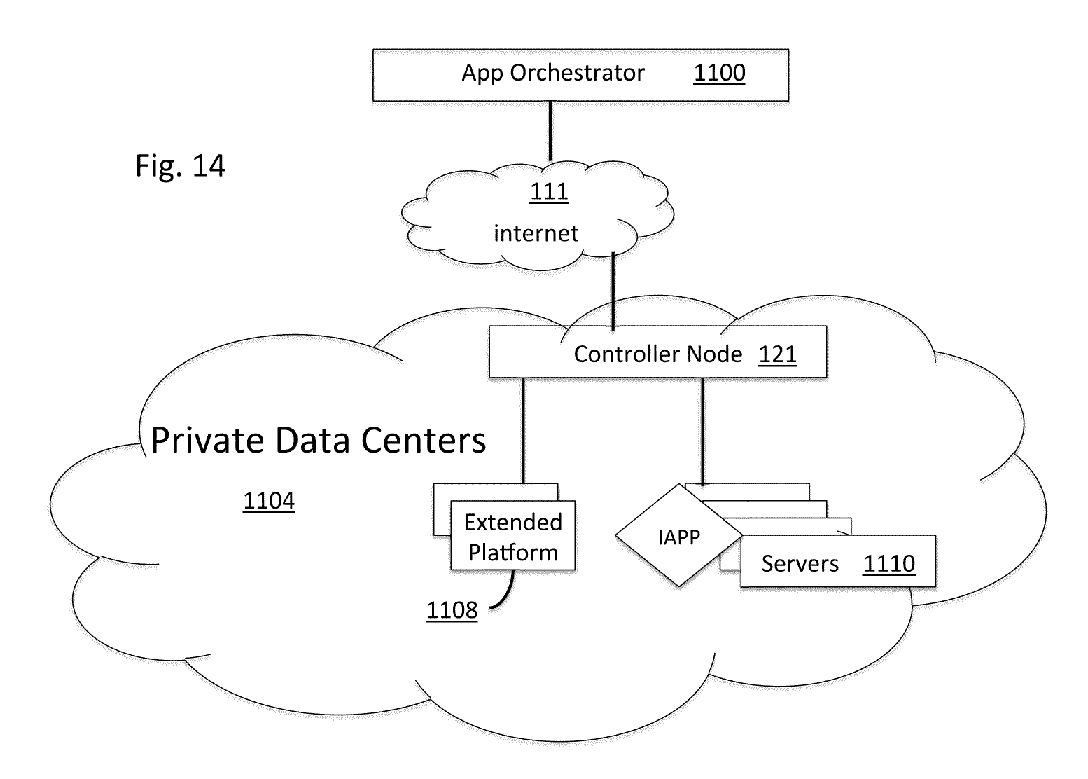

Reference is now made to FIG. 14 illustrating the application-orchestration component of the uCloud Platform in accordance with the principles of the present invention. The app orchestrator performs the process of tracking service offerings that are logically connected to SDC's. It takes the requests from the service catalog and deterministically retrieves information on what compute Nodes and vAppliances are part of a given SDC. It launches service catalog applications within the compute nodes that are connected to a targeted SDC.

The process is as follows:

1. receive request for launch of a virtual application from service catalog 508.

2. retrieve information on destination of the request (which SDC in which tenant environment)

3. Retrieve information of what devices compute Nodes and vAppliances are involved in the SDC

4. once it determines the above, the app orchestrator sends a configuration to launch these virtual applications to the controller Node.

Additionally, the app orchestrator will be used in conjunction with the app monitor in the uCloud platform 100 as well as the monitoring controller present in the controller node in the extended platform to a) receive requests from controller node and b) access the relevant tenant extended platform, determines the impacted SDC, and c) perform appropriate corrective action.

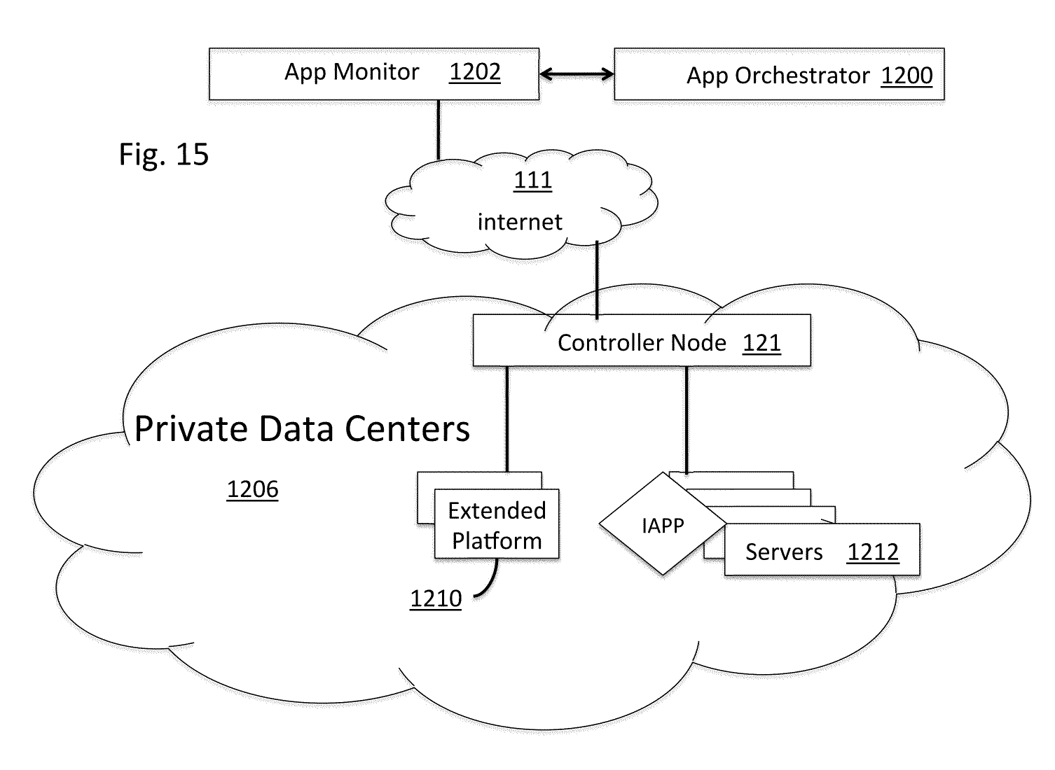

Reference is now made to FIG. 15 illustrating the integration of the application-orchestration and application-monitoring components of the uCloud Platform in accordance with the principles of the present invention. FIG. 15 illustrates part of the Monitoring functionality of the uCLoud platform 100. Through use of the monitoring controller, the app monitor collects health information of the extended platform (as detailed herein above). In addition, a tenant can define a “disruptive event”. In the event of a disruptive event the monitoring controller will alert the app orchestrator to perform corrective action. The monitoring controller performs corrective action by rebuilding relevant portions of extended platform control plane.

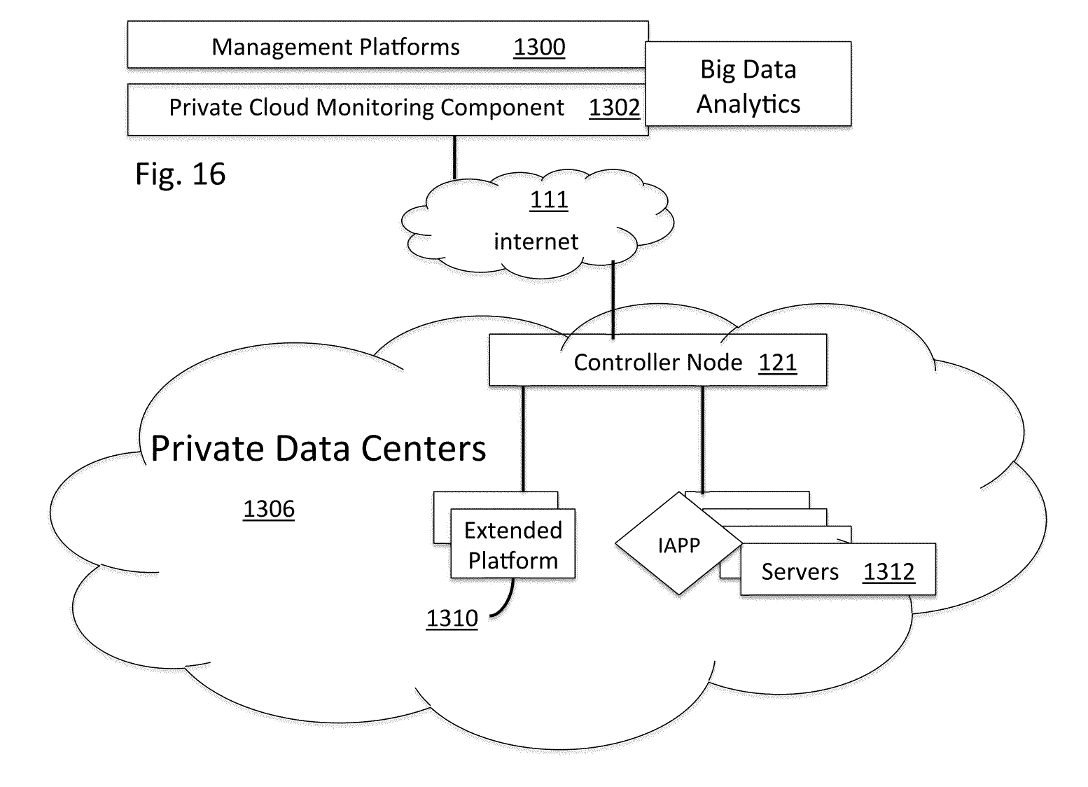

Reference is now made to FIG. 16 illustrating the big data component of the uCloud Platform 100 and the relationship to the monitoring component of the platform. Based on the data collected by the Controller Node 121 that is relayed to the Platform and stored in a Database, an analysis can be made of, a) SDC and compute nodes usage, and b) disruptive events reported. Heuristics of cloud usage is tracked by the Controller Node. Heuristic algorithmic analysis is used in 100 to understand aspects of tenant cloud usage.

SDC instance information is collected from the SDC management plane by the tenant cloud instance manager. (achieved by a) tenant cloud instance manager sending a command to the controller node via the message bus, b) controller node uses the command to retrieve collected information from the correct SDC management plane, c) information is relayed to tenant cloud instance manager, d) information is stored in a database)

SDC instance Information refers to Data about services usage, services types, SDC networking, compute, storage consumption data. This Data is collected continuously (via process outlined above) and archived to an external Big Data database (1303, contained in 100).

Big data analytics engine processes the gathered information and performs heuristic big data analysis to determine cloud tenant services usage, services types, SDC networking, compute, storage consumption data, and then suggests optimal cloud deployment for tenant (through web interface in 100).

This analysis can contain a determination of high priority events, and report it to the relevant administrators 102A, and 102B. Additional analysis can be made using business metrics and return on investment computations.

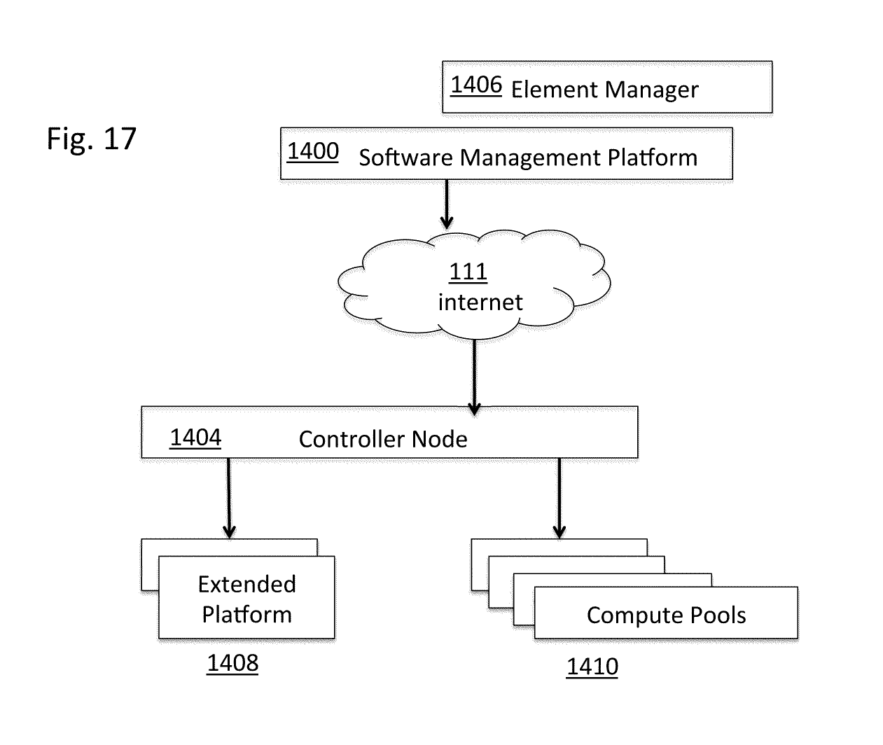

Reference is now made to FIG. 17 illustrates the process of deploying uCloud within an Enterprise environment. Using gathered information on compute nodes 120a-n, uCloud Platform 100 creates a customized package that contains a Controller Node 121, designed for the Enterprise 101. Administrator 102B then downloads and installs Controller Node 121 into the Enterprise environment 101. The uCloud Platform then orchestrates the infrastructure within the Enterprise environment, via the Controller Node. This includes configuration of router nodes 122, firewall node 123, compute Nodes 120a-n, as well as any storage infrastructure.

FIG. 17 represents a holistic view of the cloud management platform capabilities of uCloud Platform. The platform is separated into the hosted platform 100 and the management platform.

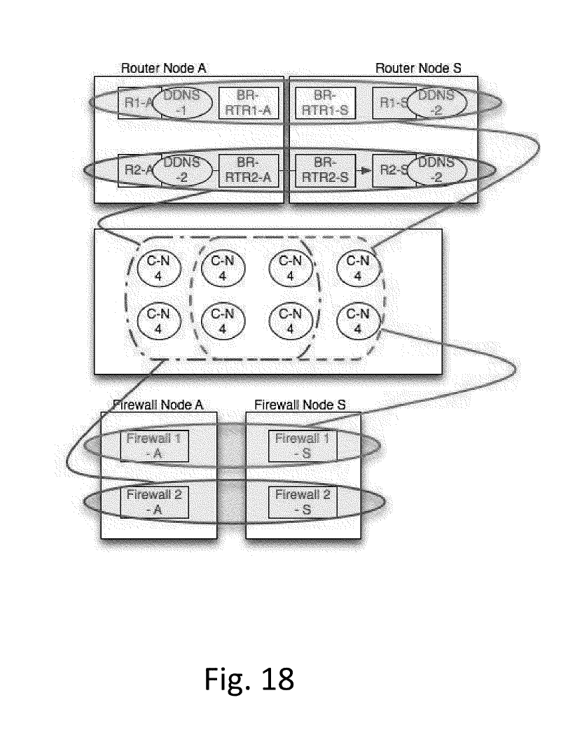

The uCloud Platform 100 can support many tenants recalling that a tenant is defined as an enterprise or a service provider. The multi tenant concept can be seen in FIG. 2, as well as in FIG. 3. The tenant environment prior to deployment of uCloud is a collection of Compute Nodes. Post uCloud deployment, the environment, now called a private cloud, comprises an extended platform and compute nodes. The extended platform comprises of a limited number of Nodes dedicated for the logical creation of clouds (SDC's). The compute Nodes are used as Enterprise resources, and can be part of a single or multiple SDC's, or software defined clouds. The SDC concept is seen in FIG. 4. This is referred to as the “logical view” of the private cloud. The division of the extended platform and the compute nodes is seen in FIG. 1. This will be referred to as the “hardware view” of the private cloud. The combination of the logical and hardware views is seen in (FIG. 18). As mentioned, the extended platform consists of several Nodes (servers). Each Node will run specific types of virtual Appliances, or vAppliances, that regulate and create logical boundaries for an SDC. Every SDC will contain a specific set of vAppliances. The shaded regions of (FLOW 1) represent exclusive use of a set of vAppliances by a specific SDC. The Compute Nodes of a private cloud, seen in FIG. 1 and in FLOW as C-N, are a resource that can be shared between multiple SDC's. This sharing concept is seen in FIG. 18.

The uCLoud Platform manages SDC's by providing several features that will assist a tenant in operating the private cloud. These features include, but are not restricted to, a) service catalog of virtual applications to be run on a given SDC, b) monitoring of SDC's, c) Big Data analytics of SDC usage and functionality, and d) hierarchical logic dictating access to SDC's/virtual applications/health information/or other sensitive information. The process of performing each feature has been shown in FIGS. 5-14.

The uCloud Platform configuration process is summarized as follows: Using gathered information on compute nodes 120a-n, uCloud Platform 100 creates a customized package that contains a Controller Node 121, designed for the Enterprise 101. 102B then downloads and installs 121 into the Enterprise environment 101. The uCloud Platform then orchestrates the infrastructure within the Enterprise environment, via the Controller Node. This includes configuration of router nodes 122, firewall node 123, compute Nodes 120a-n, as well as any storage infrastructure. The combination of all uCLoud Platform components in the hosted and extended platforms allows for the operation of a multi-tenant, multi-User, scalable Private cloud.

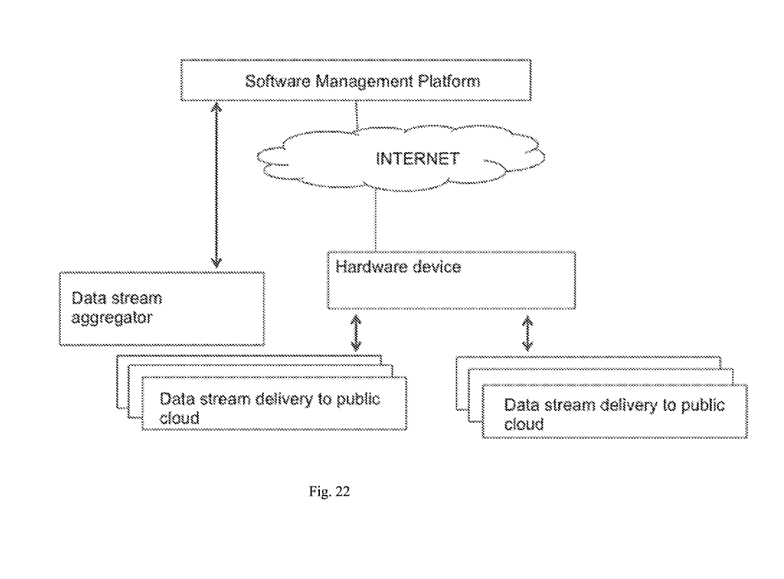

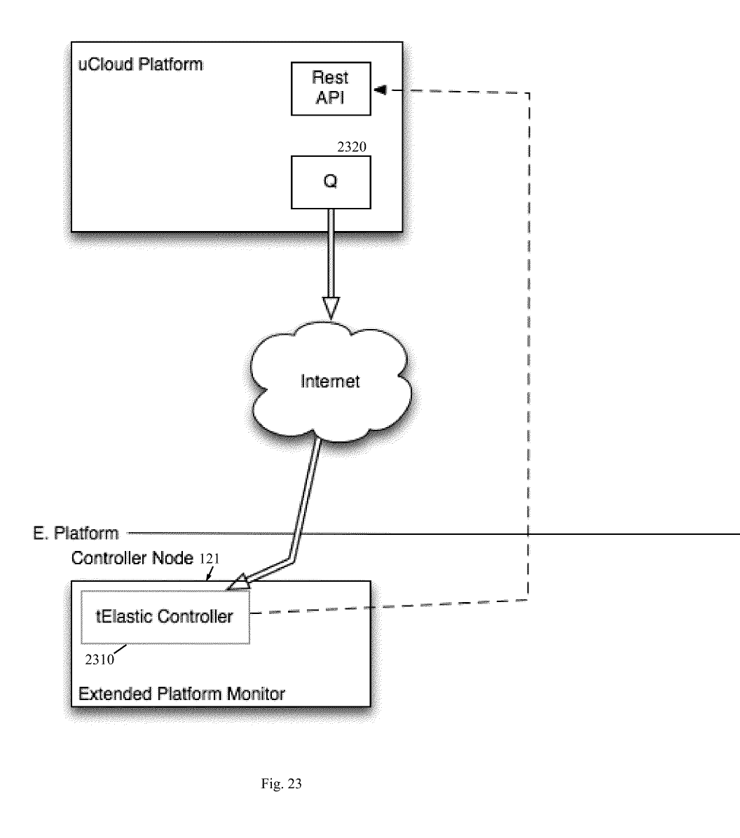

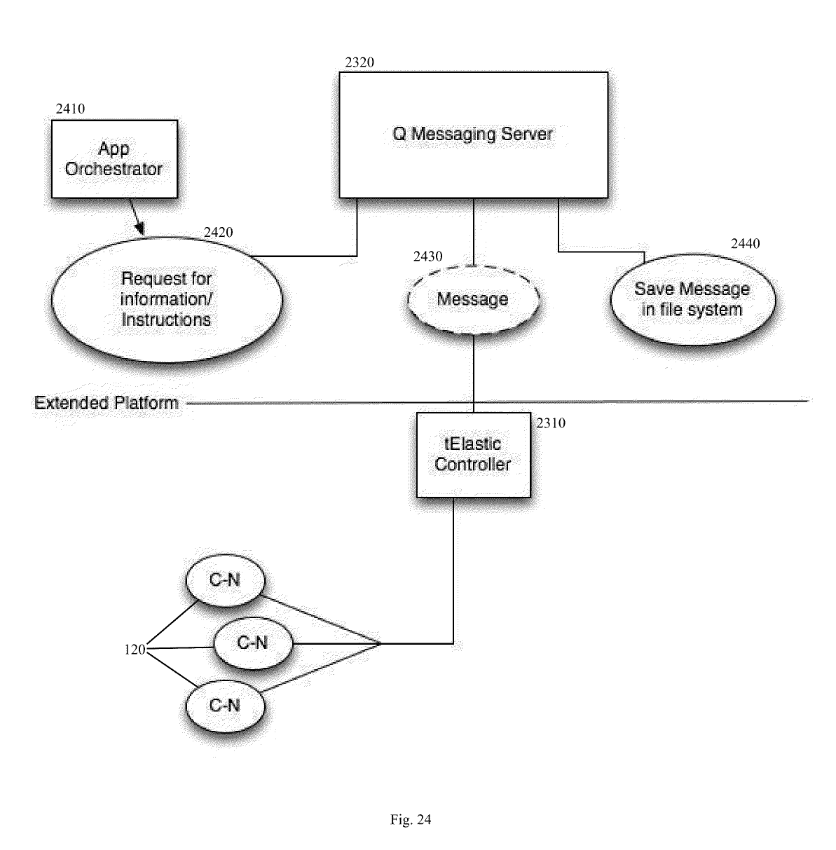

FIGS. 22-24 illustrate embodiments of systems and methods for secure transmission of data to and from a tenant environment to the uCloud Platform to the tenant environment. FIG. 22 is a block diagram of an overview of an embodiment of a system according to the current invention. FIGS. 23 and 24 are block diagram of embodiment of a system according to the current invention.

Due to the nature of secure networking, it is not ideal to allow direct external access to a secure tenant environment. In order to allow the transmission of data from the uCloud Platform to a tenants environment, a system is created in the following manner. A tenant is onboarded initially, reserving certain nodes for the uCloud extended platform. This extended platform includes router nodes, firewall nodes, as well as a controller node 121. This controller node 121 will contain several components. One such component is the tElastic Controller 2310. The tElastic Controller 2310 is a vAppliance, similar to the router, firewall, DDNS, and bridge router vAppliances shown in FIG. 18. The tElastic Controller 2310 serves as a Data stream aggregator, and will receive information from the uCloud Platform via a secure datastream.

Appropriate templates are downloaded in the nodes 120 reserved for the extended platform, an element corresponding to the tElastic Controller 2310 is created in the uCloud Platform. This element is called the Q. Together, both components will create a secure channel through which the tElastic Controller 2310 can receive messages, and execute commands.

In order to initial configuration of the tElastic Controller 2310, the tenant is onboarded, tenant specifies nodes for Extended Platform, templates are downloaded for vAppliances, and a connection is established with Q in the uCloud Platform. In the initial connection, authentication of the tElastic Controller is performed by the uCloud Platform. The data stream is created through which the Q will communicate messages and commands to the tElastic Controller 2310.

In operation, in the exemplary process, the application orchestrator utilizes the secure data stream to execute a certain result pertaining to the compute nodes 120 of a tenant's private cloud. The application orchestrator receives a compute node related request from a manager within uCloud Platform. The application orchestrator is in cooperation with the Q to create a simple data packet containing instructions for the tElastic Controller, as well as a return address. The tElastic Controller 2310 receives the data packet and executes the commands in the appropriate compute nodes 120. The tElastic Controller 2310 sends a message confirming the completion of the task to the uCloud Platform via a protocol such as RestAPI call (show in FIG. 1 in 100).

The Q receives data packets via a redundant system of messaging servers. In order to guarantee delivery of the messages, the following process is implemented to the system. Messaging servers of Q receive data packet with instructions for/requests for information from compute nodes 120 of the tenant private cloud. These instructions are sent to the tElastic Controller. Messaging servers save a copy of the message in memory as well as in a file system. The Q sends messages to controller node 121. If the tElastic Controller 2310 is overcapacity due to requests or the controller node 121 is non-responsive, the Extended Platform Monitor notifies the tenant administrator of the event. After the controller node 121 becomes available, the queued messages are delivered.

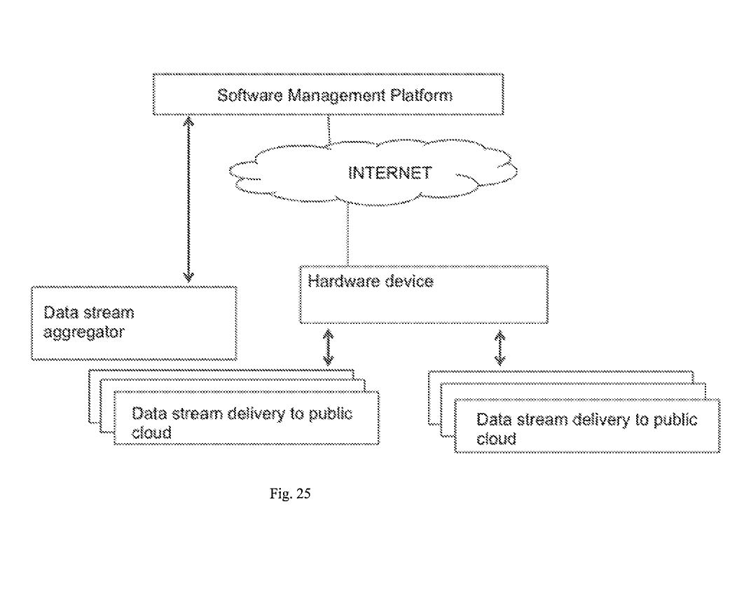

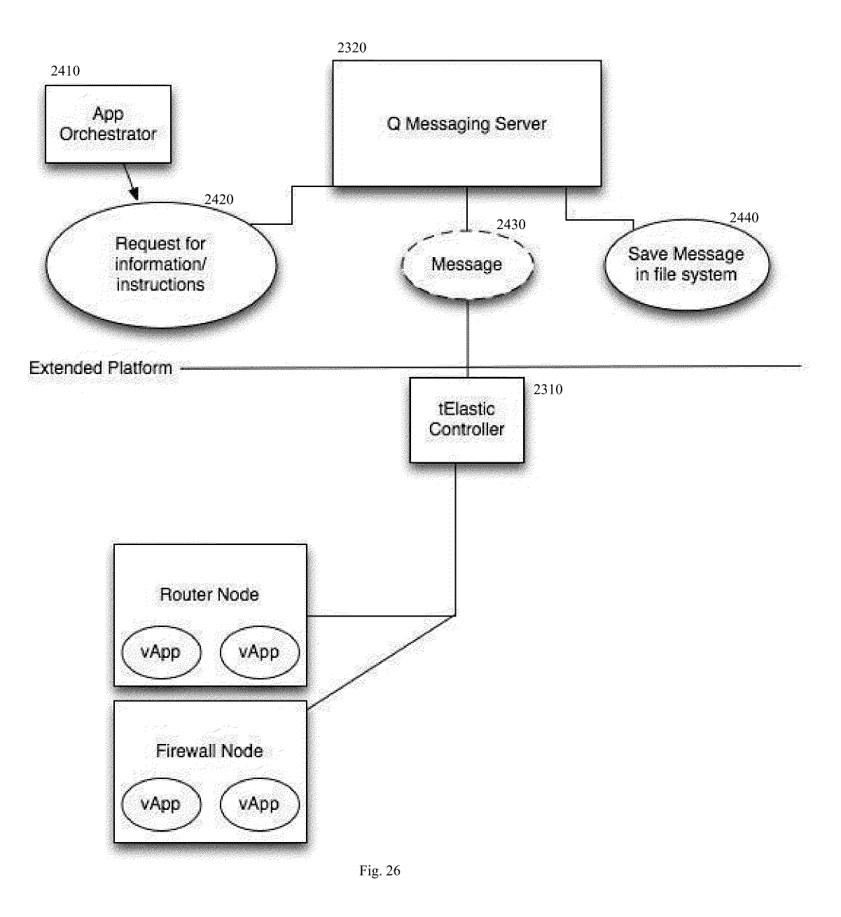

FIGS. 25 and 26 illustrate alternate embodiments of the invention which facilitate use of the secure data stream to execute network related instructions within the configured capabilities of a tenant's private cloud. The application orchestrator receives a network related request (for example router nodes, firewall nodes, vAppliances) from a manager within the uCloud Platform. The application orchestrator coordinates with the Q to create a simple data packet containing instructions for the tElastic Controller 2310, as well as a return address. The tElastic Controller 2310 receives the data packet and executes the commands in the appropriate network related device, or through the extended platform monitor. The tElastic Controller 2310 sends a message confirming the completion of the task to the uCloud Platform via protocol such as a RestAPI call (seen in FIG. 1 in 100).

The Q receives data packets via a redundant system of messaging servers. In order to guarantee delivery of the messages, the following process is implemented to the system. Messaging servers of Q receive data packet with instructions for/requests for information from compute nodes 120 of the tenant private cloud. These instructions are sent to the tElastic Controller. Messaging servers save a copy of the message in memory as well as in a file system. The Q sends messages to controller node 121. If the tElastic Controller 2310 is overcapacity due to requests or the controller node 121 is non-responsive, the Extended Platform Monitor notifies the tenant administrator of the event. After the controller node 121 becomes available, the queued messages are delivered.

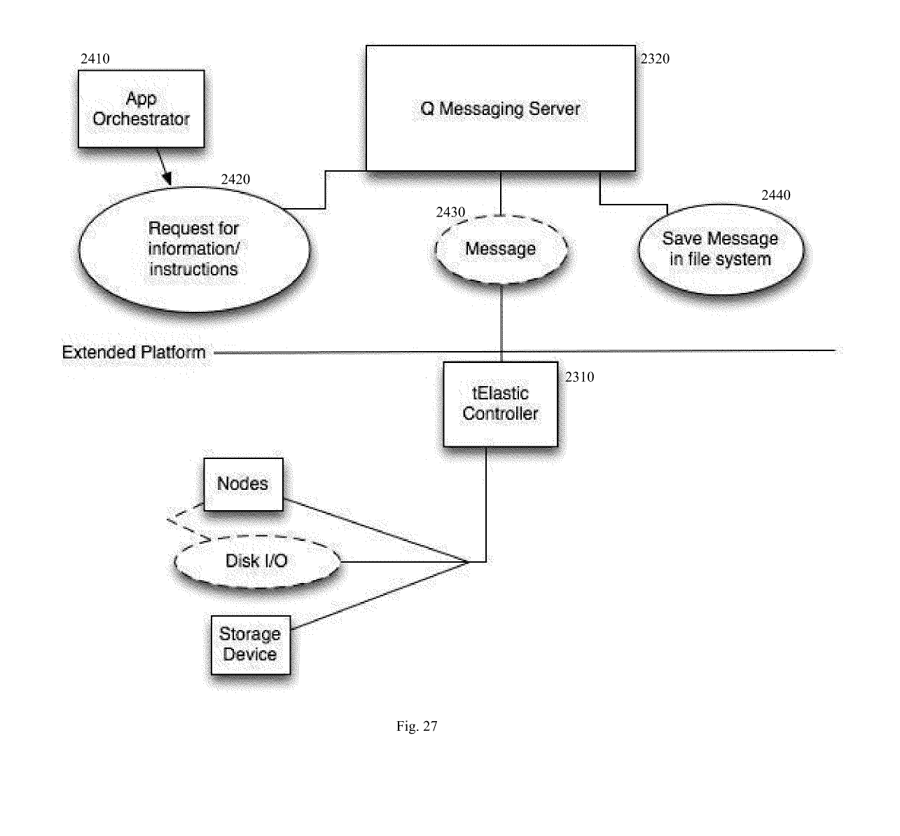

FIG. 27 illustrates an alternate embodiment of the invention which facilitates use of the secure data stream to execute network related instructions within the configured capabilities of a tenant's private cloud. The application orchestrator receives a storage related request (for example disk storage or other I/O device) from a manager within the uCloud Platform. The application orchestrator coordinates with the Q to create a simple data packet containing instructions for the tElastic Controller 2310, as well as a return address. The tElastic Controller 2310 receives the data packet and executes the commands in the appropriate network related device, or through the extended platform monitor. The tElastic Controller 2310 sends a message confirming the completion of the task to the uCloud Platform via protocol such as a RestAPI call (seen in FIG. 1 in 100).

The Q receives data packets via a redundant system of messaging servers. In order to guarantee delivery of the messages, the following process is implemented to the system. Messaging servers of Q receive data packet with instructions for/requests for information from compute nodes 120 of the tenant private cloud. These instructions are sent to the tElastic Controller. Messaging servers save a copy of the message in memory as well as in a file system. The Q sends messages to controller node 121. If the tElastic Controller 2310 is overcapacity due to requests or the controller node 121 is non-responsive, the Extended Platform Monitor notifies the tenant administrator of the event. After the controller node 121 becomes available, the queued messages are delivered.

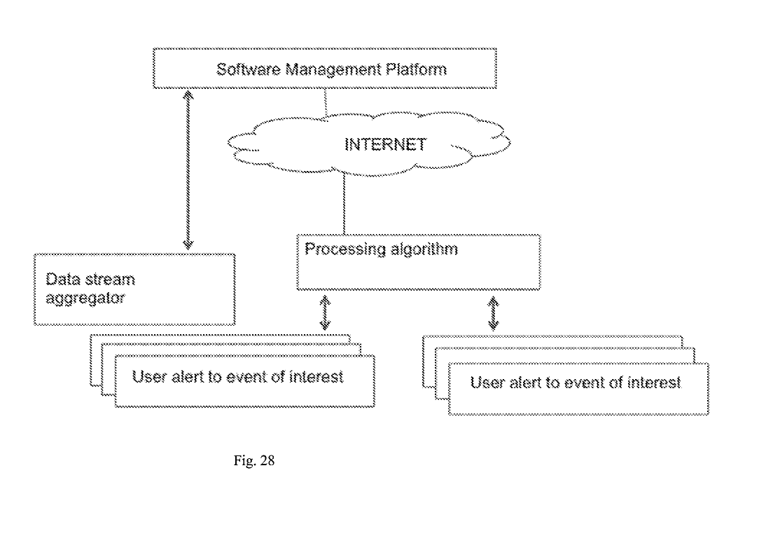

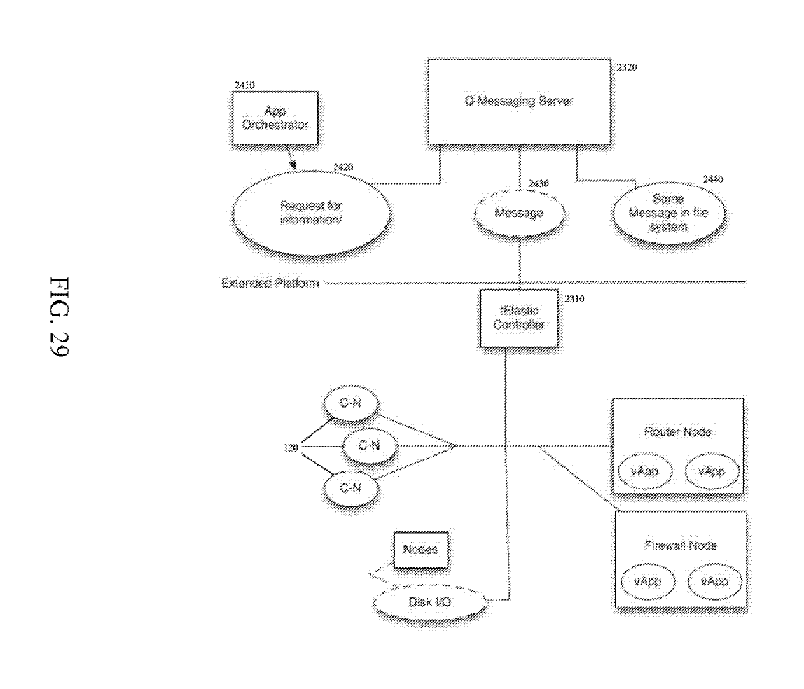

FIGS. 28 and 29 illustrate alternate embodiments of the invention which facilitate use of the secure data stream to execute storage, network, and compute related instructions within the configured capabilities of a tenant's private cloud. The application orchestrator receives a request from a manager within the uCloud platform (for example compute node, router nodes, firewall nodes, vAppliances, disk storage) from a manager within the uCloud Platform. The application orchestrator coordinates with the Q to create a simple data packet containing instructions for the tElastic Controller 2310, as well as a return address. The tElastic Controller 2310 receives the data packet and executes the commands in the appropriate network related device, or through the extended platform monitor. The tElastic Controller 2310 sends a message confirming the completion of the task to the uCloud Platform via protocol such as a RestAPI call (seen in FIG. 1 in 100).

The Q receives data packets via a redundant system of messaging servers. In order to guarantee delivery of the messages, the following process is implemented to the system. Messaging servers of Q receive data packet with instructions for/requests for information from compute nodes 120 of the tenant private cloud. These instructions are sent to the tElastic Controller. Messaging servers save a copy of the message in memory as well as in a file system. The Q sends messages to controller node 121. If the tElastic Controller 2310 is overcapacity due to requests or the controller node 121 is non-responsive, the Extended Platform Monitor notifies the tenant administrator of the event. After the controller node 121 becomes available, the queued messages are delivered.

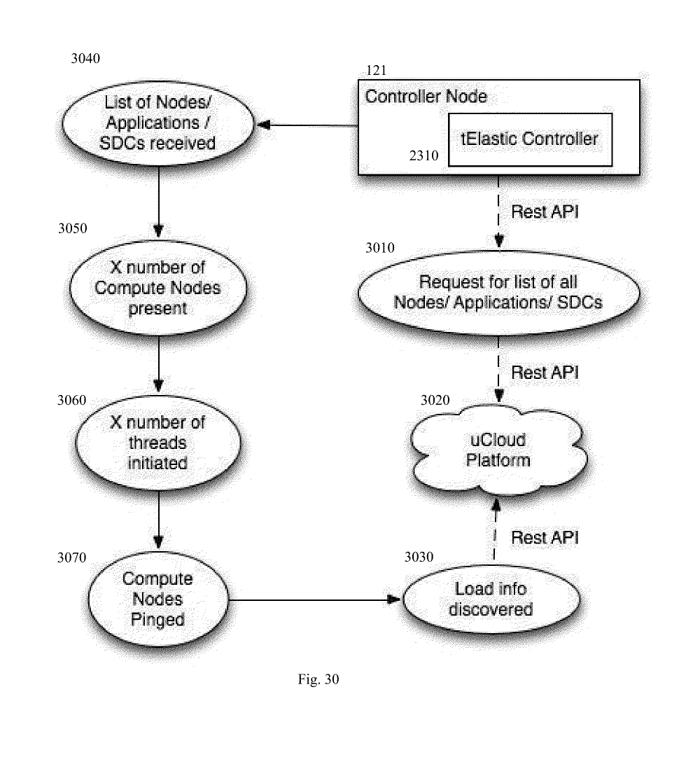

FIG. 30 illustrates systems and methods of the current invention which facilitate monitoring compute nodes and extended platform appliances. The tElastic controller 2310 creates threads (processes) related to one particular task the tElastic controller needs to perform. Representative types of threads include Q thread, extended platform monitoring, metering, and toggle monitoring. It should be understood that each thread can create sub-threads in order to allow for multiple requests to be fulfilled in parallel. The status of the extended platform, including SDCs, hardware, VMs, and SDC tunnels is monitored. The extended platform includes all nodes which tenants have onboarded and all vAppliances that reside in a tenant private cloud.

The compute devices will be monitored in the following methods. The tElastic Controller 2310 sends a request for a list of all nodes, applications, and SDC tunnels via the Rest API interface to the uCloud platform 3010. This list will be returned via Rest API 3040. The tElastic Controller 2310 will then take this list and initiate a certain number threads (processes) according to the number of compute nodes present 3050 3060. After the device list is returned, the controller 2310 has the names, passwords, and IP addresses of all compute nodes 3050 3060. The controller will ping the node, and discover the load of the node 3070. The response load tells us the average of the machine load in the last 1, 5, 15 minutes, or other poolling interval 3030. This includes CPU, memory, and other compute node resource information.

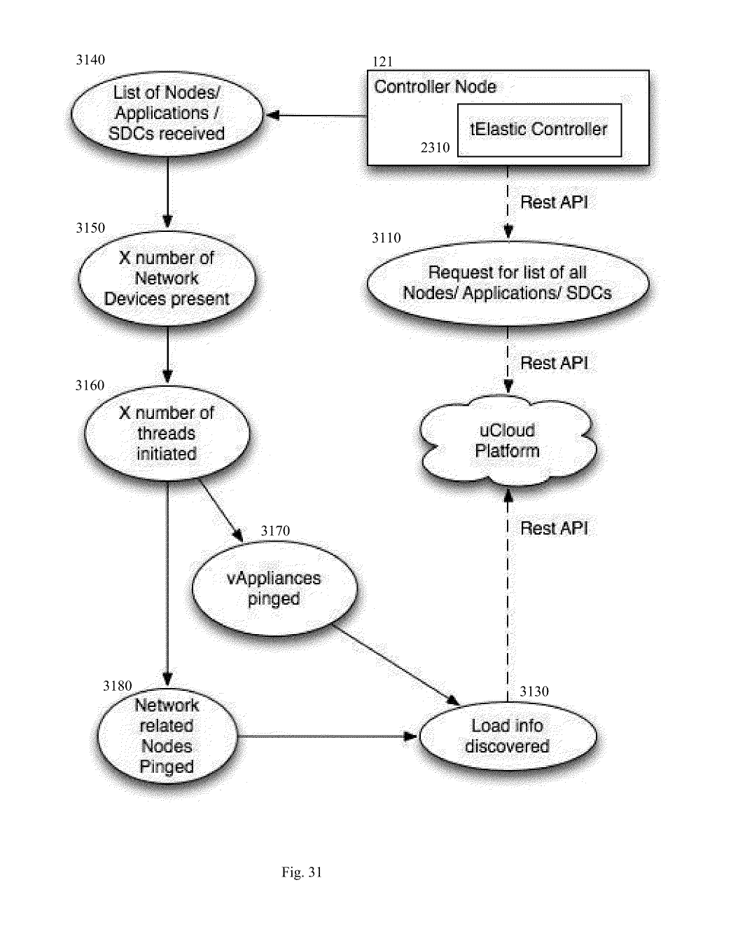

FIG. 31 illustrates systems and methods of the current invention which facilitate monitoring the extended platform, including SDCs, hardware, VMs, and SDC tunnels. The extended platform includes nodes which the tenant has onboarded and vAppliances that reside in a tenant private cloud.

The real-time monitoring of this embodiment occurs in the following steps. The tElastic Controller 2310 will send a request for a list of all nodes, applications, and SDC tunnels via the Rest API interface to the uCloud platform 3110. This list will be returned via Rest API 3140. The tElastic Controller 2310 will then take this list and initiate a certain number threads (processes) according to the number of network devices present 3150 3160. This includes router and firewall nodes, network related vAppliances, and tunnels. Once devices list is returned, the controller has the names, passwords, and IP addresses of all router and firewall nodes. The controller will ping the node, and discover the load of the node 3170. The load tells us the average of the machine load in the last 1, 5, 15 minute, or other interval. This includes CPU, memory, or other computing resources. The router, firewall, bridge router, and DDNS vAppliances are also checked for load 3180. A list of tunnels is also provided in the devices list. Processing this information facilitates discovery of the node topology 3130. The controller will secure shell into a node in an SDC, test the tunnels by sending a ping to all nodes connected to it via tunnels. This will be repeated n*(n−1) times. This packet loss rate is also calculated. The controller node will return the result of this periodic testing to the uCLoud platform.

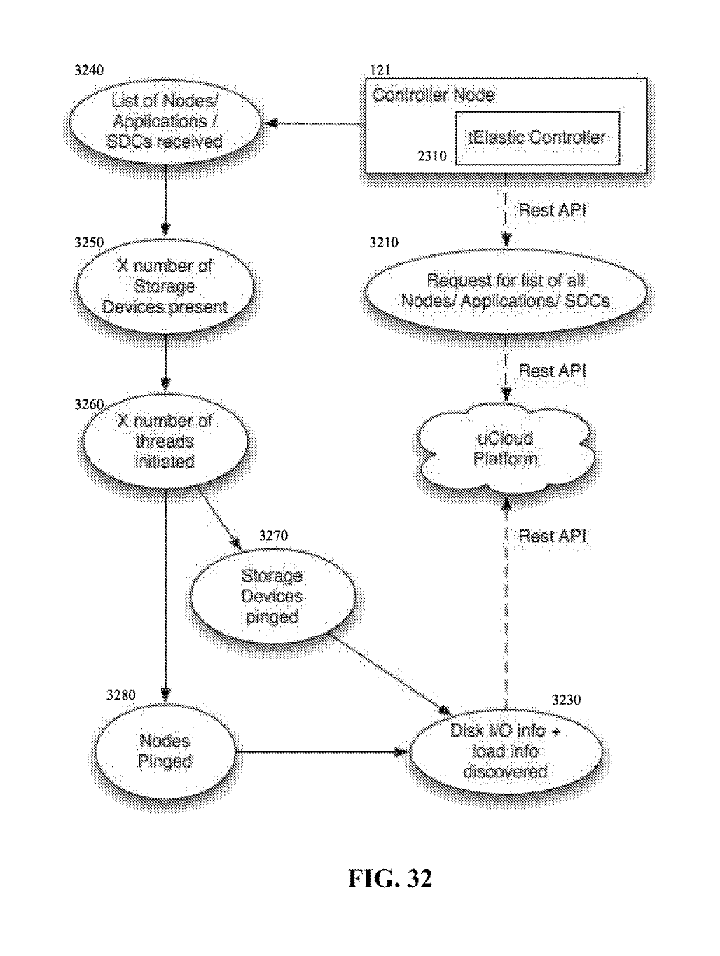

FIG. 32 illustrates an embodiment of systems and methods of the current invention which facilitate monitoring the storage devices. The real-time monitoring of this embodiment occurs in the following steps. The tElastic Controller 2310 will send a request for a list of all nodes, applications, and SDC tunnels via the Rest API interface to the uCloud platform 3210. This list will be returned via Rest API 3240. The tElastic Controller 2310 will then take this list and initiate a certain number threads (processes) according to the number of storage devices present 3250 3260. Once the devices list is returned, the controller has the names, passwords, and IP addresses of all router and firewall nodes. The controller will ping the storage devices, and discover the load of the storage devices 3170. The load tells us the average of the disk I/O in the last 1, 5, 15 minute, or other interval. This includes CPU, memory, or other computing resources. The router, firewall, bridge router, and DDNS vAppliances are also checked for load 3180. A list of tunnels is also provided in the devices list. Processing this information facilitates discovery of the node topology 3130. The controller will secure shell into a node in an SDC, test the tunnels by sending a ping to all nodes connected to it via tunnels. This will be repeated n*(n−1) times. This packet loss rate is also calculated. The controller node will return the result of this periodic testing to the uCLoud platform.

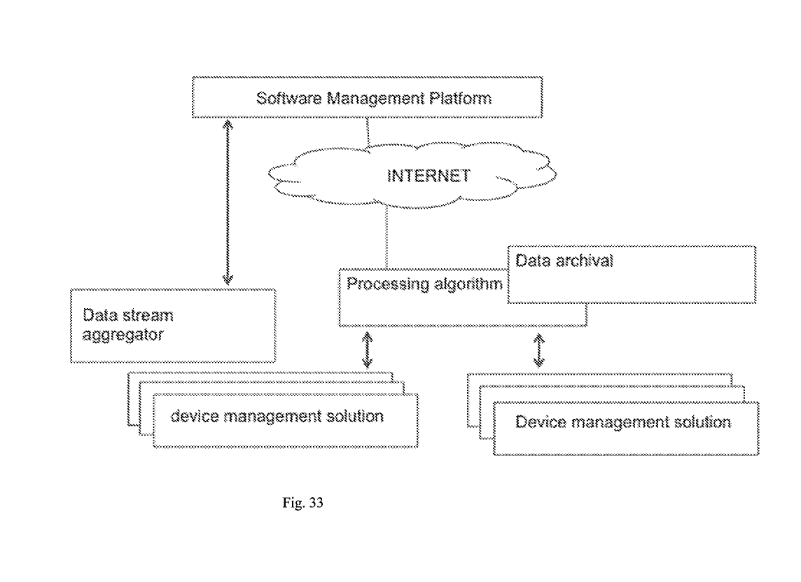

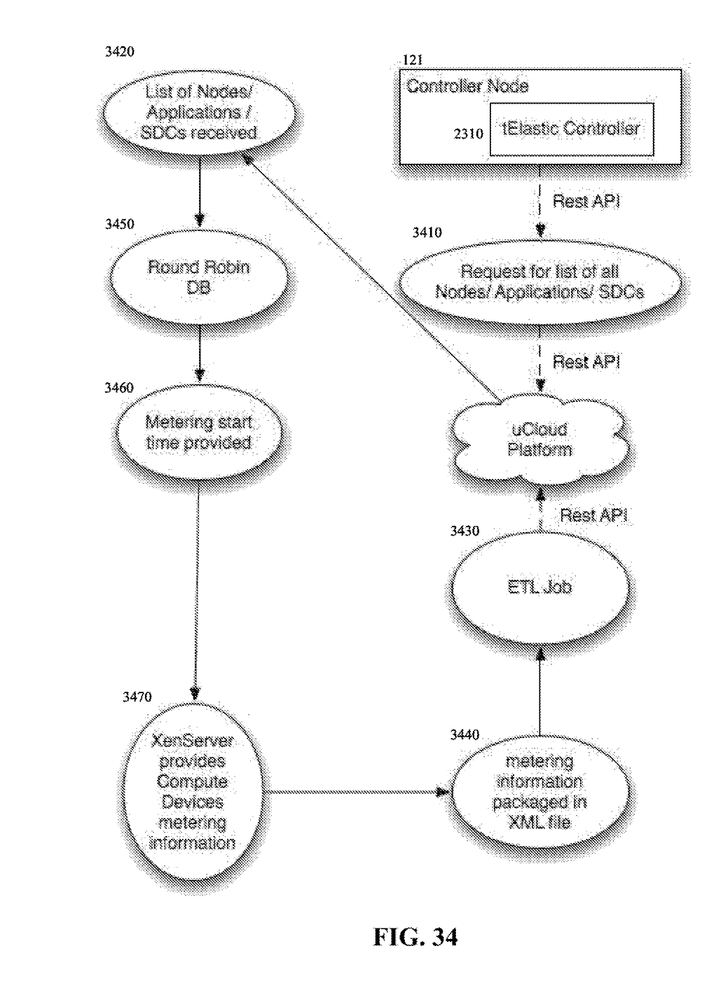

FIGS. 33 and 34 illustrate an embodiment of systems and methods of the current invention which facilitate monitoring of tenant performance. Initially, data is collected for the generation of reports using the following process. The controller 121 starts a metering thread periodically. A list of devices, appliances, and SDC tunnels is requested from the uCloud Platform via a REST API 3410. In other configurations, SOAP or other protocolos are employed. A list is provided via REST API 3420. The controller will collect statistics of Compute devices usage for a specific amount of time.

For the collection process, the following steps are used. Once the list is provided, the controller has the password, login and name of all the devices. The round robin database contains records of all statistics recorded by the virtualization server (for example XenServer) of the nodes and the VMs running on the nodes 3450. This information is collected and stored at different intervals, for example the last 2 hours, last week, last day, or other time period. The various process threads initiated by the tElastic Controller 2310 for collection purposes pull the relevant information from the virtualization server for each device 3470. The controller 121 makes a specific request for information with a start time provided 3460. The virtualization server provides the information according to how much time has elapsed since the last such request was made. This process is performed in batch (versus real time). The collected information is packaged in a format such as an XML file 3440. The platform will perform extract, transform and load process on the XML files prepared by the controller, and loads them into the business intelligence database. The database will be used for later reporting. The extract, transform, and load job is constantly running and monitoring a directory for XML files. After a file is prepared, the job processes it and loads it into the business intelligence database.

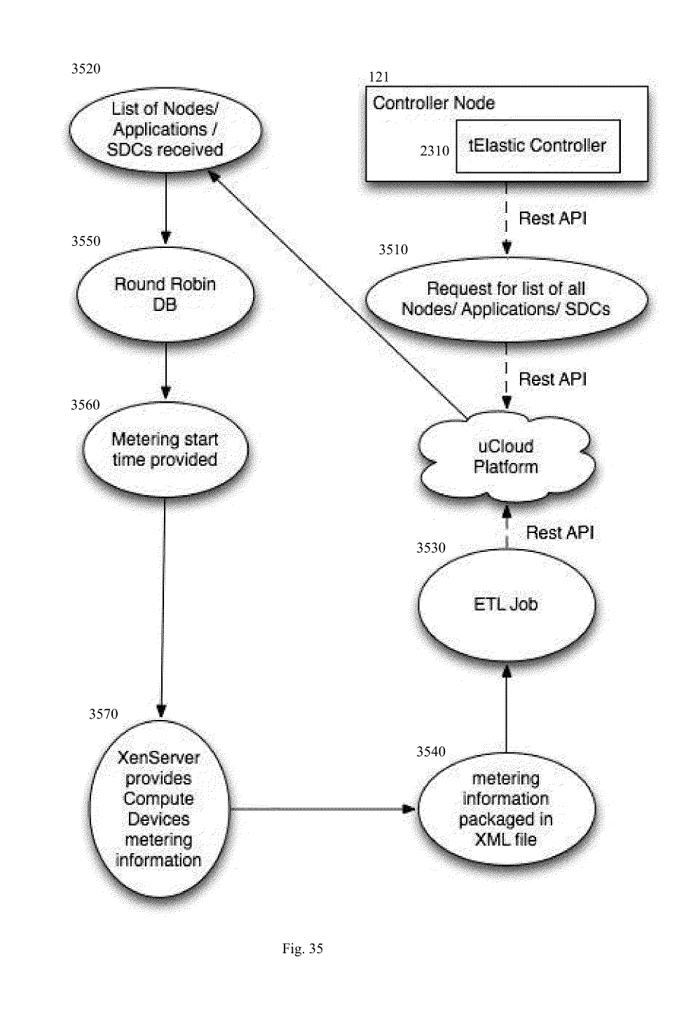

FIG. 35 illustrates an embodiment of systems and methods of the current invention which facilitate monitoring of network performance. Initially, data is collected for the generation of reports using the following process. Representative network devices include router and firewall nodes, network related vAppliances, and tunnels. The controller 121 starts a metering thread periodically. A list of devices, appliances, and SDC tunnels is requested from the uCloud Platform via a REST API 3510. In other configurations, SOAP or other protocolos are employed. A list is provided via REST API 3520. The controller will collect statistics of compute devices usage for a specific amount of time.

For the collection process, the following steps are used. Once the list is provided, the controller has the password, login and name of all the devices. The round robin database contains records of all statistics recorded by the virtualization server (for example Xenserver) of the nodes and the VMs running on the nodes 3550. This information is collected and stored at different intervals, for example the last 2 hours, last week, last day, or other time period. The various process threads initiated by the tElastic Controller 2310 for collection purposes pull the relevant information from the virtualization server for each device 3570. The controller 121 makes a specific request for information with a start time provided 3560. The virtualization server provides the information according to how much time has elapsed since the last such request was made. This process is performed in batch (versus real time). The collected information is packaged in a format such as an XML file 3540. The platform will perform extract, transform and load process on the XML files prepared by the controller, and loads them into the business intelligence database. The database will be used for later reporting. The extract, transform, and load job is constantly running and monitoring a directory for XML files. After a file is prepared, the job processes it and loads it into the business intelligence database.

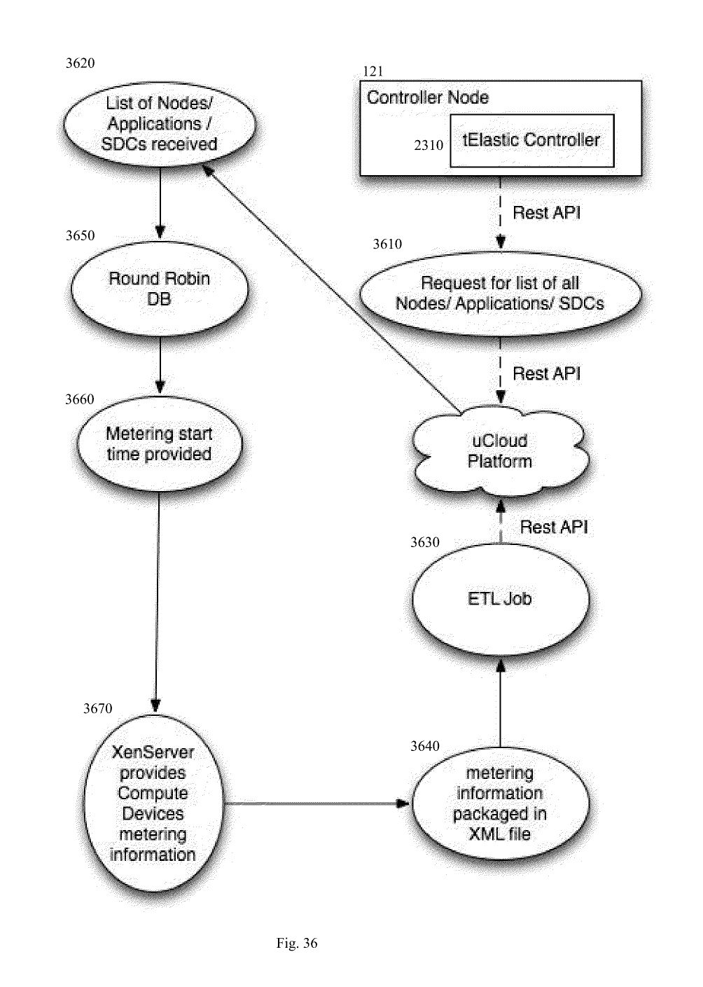

FIG. 36 illustrates an embodiment of systems and methods of the current invention which facilitate monitoring of performance across all of their assets. Initially, data is collected for the generation of reports using the following process. Representative devices include compute devices, router and firewall nodes, network related vAppliances, tunnels, and storage devices. The controller 121 starts a metering thread periodically. A list of devices, appliances, and SDC tunnels is requested from the uCloud Platform via a REST API 3610. In other configurations, SOAP or other protocolos are employed. A list is provided via REST API 3620. The controller will collect statistics of compute devices usage for a specific amount of time.

For the collection process, the following steps are used. Once the list is provided, the controller has the password, login and name of all the devices. The round robin database contains records of all statistics recorded by the virtualization server (for example Xenserver) of the nodes and the VMs running on the nodes 3650. This information is collected and stored at different intervals, for example the last 2 hours, last week, last day, or other time period. The various process threads initiated by the tElastic Controller 2310 for collection purposes pull the relevant information from the virtualization server for each device 3670. The controller 121 makes a specific request for information with a start time provided 3660. The virtualization server provides the information according to how much time has elapsed since the last such request was made. This process is performed in batch (versus real time). The collected information is packaged in a format such as an XML file 3640. The platform will perform extract, transform and load process on the XML files prepared by the controller, and loads them into the business intelligence database. The database will be used for later reporting. The extract, transform, and load job is constantly running and monitoring a directory for XML files. After a file is prepared, the job processes it and loads it into the business intelligence database.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
the collection of data that captures the status of storage devices of Private Enterprise Cloud over a specific time interval;
the aggregation of the data by a data stream aggregator;
declaratively configuring the data stream aggregator to show events of interest;
delivery of the aggregated data stream from the private enterprise cloud to a secure processing system in the public cloud through an alternate method in addition to dynamic tunneling;
archiving all events of interest in a secure processing system in the public cloud;
analysis of all events of interest; and
recommending private enterprise storage device management solutions based on archived data.

2. An apparatus, comprising:
a data stream aggregator that is declaratively configurable and remotely manageable;
hardware device used for transporting and securing aggregated data stream from a private enterprise to the public cloud in addition to dynamic tunneling based on policy based algorithm so as to guarantee delivery and security;
a processing algorithm used to detect events of interest in the data streams from the private enterprise cloud and alert users;
a storage device for archival of all events of interest; and
a software platform that can recommend storage device management solutions based on archived data.
